(19) United States
(12) Patent Application Publication
(10) Pub. No.: US 2023/0124110 A1
(43) Pub. Date: Apr. 20, 2023

(54) BANKNOTE HANDLING SYSTEM AND BANKNOTE HANDLING METHOD

(71) Applicant: Glory Ltd., Himeji-shi (JP)

(72) Inventors: Keisuke NADA, Himeji-shi (JP); Kazuhiko ORIBE, Himeji-shi (JP); Yoshikatsu MIZUSHIMA, Himeji-shi (JP)

(73) Assignee: Glory Ltd., Himeji-shi (JP)

(21) Appl. No.: 18/084,585

(22) Filed: Dec. 20, 2022

Related U.S. Application Data
(63) Continuation of application No. PCT/JP2021/025267, filed on Jul. 5, 2021.

(30) Foreign Application Priority Data
Jul. 20, 2020 (JP) 2020-123881

(51) Int. Cl. G07D 7/0047; G07D 11/32; G07D 11/13

(52) U.S. Cl. CPC G07D 7/0047; G07D 11/32; G07D 11/13; G07D 2207/00; G07D 2211/00

(57) ABSTRACT

A banknote handling system includes a controller that performs a matching process of matching of a second code of a banknote to be subjected to matching read by a recognition circuit with a first code stored in a memory, and the controller determines that the first code matches with the second code if all symbols of specific digits of the first code match with those of the second code and if the number of digits for which symbols mismatch other than the specific digits is a predetermined number or less, and determines that the first code mismatches with the second code if symbols of the specific digits of the first code mismatch with those of the second code or if the number of digits for which symbols mismatch other than the specific digits exceed the predetermined number.

### CROSS-REFERENCE TO RELATED APPLICATION

This application is a bypass continuation of International Patent Cooperation Treaty Application No. PCT/JP2021/025267 filed on Jul. 5, 2021, and claims priority to Japanese Patent Application No. 2020-123881 filed on Jul. 20, 2020, the entire disclosures of each are incorporated herein by reference.

### BACKGROUND

A conventional banknote handling machine performs a matching process of an identification number of each banknote. The identification number is a unique code for each banknote. The identification number of each banknote is also referred to as a serial number. The banknote handling machine performs matching of the identification number stored in the memory unit with the identification number of a banknote fed from the storage unit. The memory unit stores identification numbers of all banknotes stored in the storage unit. The banknote handling machine can confirm the number of banknotes remaining in the storage unit, i.e., the inventory amount in the storage unit after a banknote is fed, by performing matching of the identification number.

### SUMMARY

A banknote handling system includes: a transport member that transports a banknote having a unique code consisting of a string of a plurality of symbols; a recognition circuit that reads a code of the banknote transported by the transport member; a memory that stores a first code; and a controller that performs a matching process of matching of a second code of the banknote to be subjected to matching read by the recognition circuit with the first code stored in the memory. The controller determines that the first code matches with the second code if a symbol of at least one specific digit at a specific position of the first code all matches with that of the second code and if the number of digits for which symbols mismatch other than the at least one specific digit is a predetermined number or less, and determines that the first code mismatches with the second code if the symbol of the at least one specific digit of the first code mismatches with that of the second code or if the number of digits for which symbols mismatch other than the at least one specific digit exceeds the predetermined number.

### BRIEF DESCRIPTION OF THE DRAWINGS

FIG. 1 is a diagram for illustrating a matching method of the identification number disclosed herein.

FIG. 2 is a flowchart related to a matching process of the identification number.

FIG. 3 is a block diagram illustrating an example configuration of a banknote handling system.

FIG. 4 is a block diagram illustrating an example configuration of the banknote handling system.

FIG. 5 is a diagram for illustrating a matching method of the identification number suitable for extraction of a counterfeit note.

FIG. 6 is a diagram illustrating an example configuration of the banknote handling machine.

FIG. 7 is a block diagram illustrating a configuration of the banknote handling machine of FIG. 6.

FIG. 8 is a diagram for illustrating procedures of matching an identification number in a partial reconciliation process.

FIG. 9 is a flowchart related to a matching process of an identification number.

FIG. 10 is a flowchart related to another matching process of an identification number.

FIG. 11 is a flowchart related to setting of a specific digit.

FIG. 12 is a diagram for illustrating a matching method of an identification number.

### DETAILED DESCRIPTION

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The conventional matching process of the identification number will be described in detail below. The banknote handling machine determines that the two identification numbers match if numbers or letters of all digits match between the two identification numbers, or even if there is a digit for which a number or a letter differs in the two identification numbers but the number of such digits is less than a predetermined number. In other words, the banknote handling machine allows a mismatch of some numbers or letters in the matching of the identification number.

There are cases where the banknote handling machine cannot read or erroneously read numbers or letters of some digits due to dirt on the banknote, creases in the banknote, and various other factors. It is difficult for the banknote handling machine to reliably and accurately read all digits of the identification number printed on the banknote.

If the conditions for determining the matching of the identification number is restricted to matching of numbers or letters of all digits, the banknote handling machine does not determine that the banknote where numbers or letters of some digits are not read or the banknote where numbers or letters of some digits are erroneously read, as a banknote having a match of the identification number. In this case, the number of banknotes whose identification numbers are determined to match in the matching process may be extremely small. The banknote handling machine cannot confirm the number of banknotes remaining in the storage unit, or it takes a long time for the banknote handling machine to confirm the number.

In contrast, if the banknote handling machine allows a mismatch of numbers or letters of the predetermined number of digits or less, the number of banknotes whose identification numbers are determined to match increases while a certain degree of high matching accuracy is maintained. As a result, the banknote handling machine can quickly and relatively accurately confirm the number of banknotes remaining in the storage unit.

The matching process of the identification number can be used not only to confirm the inventory amount in the storage unit, but also to confirm the counterfeit note or a banknote suspected to be a counterfeit note. In other words, a specific identification number may be printed on the counterfeit note. The banknote handling machine performs matching of the identification numbers on the banknotes to be handled with the identification number on the counterfeit note registered, so that the counterfeit note or a banknote suspected to be a counterfeit note can be extracted from banknotes to be handled.

However, the present inventors realized that the conventional matching process may lower the matching accuracy.

For example, in the above-mentioned matching process, if banknotes to be subjected to matching are a plurality of banknotes having consecutive identification numbers, there is a high possibility of determining that the identification numbers match even if they mismatch. In other words, in the plurality of banknotes having consecutive identification numbers, the number of digits for which numbers differ is one digit or several digits. If the banknote handling machine allows a mismatch of some digits, there is a risk that all the consecutive identification numbers of the plurality of banknotes are determined as the same identification number.

For example, it is assumed that the identification numbers of three banknotes are “12345,” “12346,” and “12347,” and the identification numbers stored are “12345,” “12346,” and “12347.” Further, in the matching process, the banknote handling machine allows a mismatch of a number of one digit. It is further assumed that the banknote handling machine could not read the number of the lowest digit in the identification number of “12345.” The banknote handling machine allows a mismatch of the number of the lowest digit which could not be read, and thus can determine that the identification number read matches with all “12345,” “12346,” and “12347” stored. It is assumed that the banknote handling machine could read accurately numbers of all digits of the identification number of “12345.” The banknote handling machine allows a mismatch of a number of one digit, and thus determines that the identification number read matches with all “12345,” “12346,” and “12347” stored.

If the matching of the identification number is erroneously performed, the conventional banknote handling machine erroneously confirms the number of banknotes remaining in the storage unit after the feeding of a banknote.

For the above-mentioned determination of the counterfeit note, the identification number of the counterfeit note may have a characteristic. For example, the characteristic may be that a number or a letter of a digit at a specific position in the identification number is a predetermined number or letter. If numbers or letters of digits at specific positions in the identification number read match with characteristics of a counterfeit note, the banknote handling machine may determine that the banknote is a counterfeit note or a banknote suspected to be a counterfeit note even if numbers or letters at other positions mismatch.

However, even if numbers or letters of digits at specific positions in the identification number read match with characteristics of a counterfeit note in the matching process, the banknote handling machine determines that the identification number of the banknote mismatches with that of the counterfeit note if the number of digits for which numbers or letters mismatch at positions other than the specific positions exceeds the predetermined number. The banknote handling machine may miss a counterfeit note or a banknote suspected to be a counterfeit note.

The present disclosure relates to a banknote handling system. The banknote handling system includes: a transport unit that transports a banknote having a unique code consisting of a string of a plurality of symbols; a recognition unit that reads a code of the banknote transported by the transport unit; a memory unit that stores a first code; and a control unit that performs a matching process of matching of a second code of the banknote to be subjected to matching read by the recognition unit with the first code stored in the memory unit. The control unit determines that the first code matches with the second code if a symbol of at least one specific digit at a specific position of the first code all matches with that of the second code and if the number of digits for which symbols mismatch other than the at least one specific digit is a predetermined number or less, and determines that the first code mismatches with the second code if the symbol of the at least one specific digit of the first code mismatches with that of the second code or if the number of digits for which symbols mismatch other than the at least one specific digit exceeds the predetermined number.

The banknote handling system with such a configuration can perform the matching of the code of the banknote with high accuracy.

The control unit may receive an input signal related to the at least one specific digit and set the at least one specific digit based on the input signal.

The memory unit may store correspondence information between an attribute of the banknote and the at least one specific digit, and the control unit may set the at least one specific digit based on the attribute of the banknote to be subjected to matching.

The control unit may receive an input signal related to an attribute of the banknote and set the at least one specific digit based on the input signal.

The recognition unit may further recognize an attribute of the banknote to be subjected to matching, and the control unit may set the at least one specific digit based on the attribute recognized by the recognition unit.

The banknote handling system may further include: at least one storage unit for storing a banknote. The control unit may perform the matching process of a banknote fed out from the at least one storage unit, the at least one storage unit may store a banknote of the same attribute, and the control unit may set the at least one specific digit based on the at least one storage unit which has fed out the banknote.

The at least one specific digit may be set based on a characteristic of the code.

The control unit may set the at least one specific digit based on a characteristic of the second code read by the recognition unit.

The code may include at least two types of symbols among a number, a letter, and a mark, and the at least one specific digit may include at least one digit for any one of the types of symbols.

The at least one specific digit may include a digit for a number.

The code may include a plurality of digits for a string of numbers, and the at least one specific digit may include a lowest digit in the string of numbers.

The control unit may perform various types of processes related to the banknote, each of the various types of processes being performed with the matching process, and the at least one specific digit may be set according to a type of a process performed.

The memory unit may store the first code related to a counterfeit note and a specific digit corresponding to the first code, and the control unit may perform a process of extracting a counterfeit note by performing the matching process using the first code.

The banknote handling system may further include: at least one storage unit for storing a banknote. The memory unit may store codes of all the banknotes stored in the at least one storage unit as the first code, the recognition unit may read the code of the banknote fed out from the at least one storage unit as the second code, and the control unit may perform a reconciliation process of confirming the number of banknotes stored in the at least one storage unit by performing the matching process.

The code may include a plurality of digits for a string of numbers and a digit of a letter, the at least one specific digit may consist of the predetermined number of digits including the lowest digit in the string of numbers, and the control unit may screen for the digits for numbers in the code of the banknote read by the recognition unit sequentially from the lowest digit to higher digits, and set the predetermined number of digits from the digit for a number first found, as the at least one specific digit.

The control unit may not set the at least one specific digit in a case where there is an unreadable digit before the digit for a number is found in the screening.

The banknote handling system may further include: a storage unit for storing a banknote. The recognition unit may read a code of the banknote before the storage unit stores the banknote, the control unit may set the at least one specific digit based on the code read, the memory unit may store the code read, as the first code, the recognition unit may read a code of the banknote fed out from the storage unit, as a second code, the control unit may set the at least one specific digit based on the second code read, and the control unit may perform the matching process according to the at least one specific digit in a case where the at least one specific digit is set in at least one of the storing or the feeding.

The control unit may determine that the first code mismatches with the second code if the at least one specific digit cannot be set in both the storing and the feeding or if a position of the at least one specific digit set differs between the storing and the feeding.

A banknote handling method disclosed herein includes: storing, in a memory unit, a first code as a unique code of a banknote; transporting the banknote by a transport unit; reading, by a recognition unit, a code of the banknote transported by the transport unit as a second code; and performing, by a control unit, a matching process of matching the second code read by the recognition unit with the first code stored in the memory unit for the banknote to be subjected to matching, wherein each of the codes includes a string of a plurality of symbols and has at least one digit at a specific position set to be a specific digit, and the control unit determines that the first code matches with the second code if the symbol of the at least one specific digit of the first code all matches with that of the second code and if the number of digits for which symbols mismatch other than the at least one specific digit is a predetermined number or less, and determines that the first code mismatches with the second code if the symbol of the at least one specific digit of the first code mismatches with that of the second code or if the number of digits for which symbols mismatch other than the at least one specific digit exceeds the predetermined number.

Embodiments of the banknote handling system and the banknote handling method will now be described below with reference to the drawings. The banknote handling system and the banknote handling method described below are mere examples.

(Matching Method of Code)

The banknote handling system disclosed herein performs a matching process of a unique code in each banknote. The code of the banknote is provided on the banknote and for specifying the banknote, and includes symbols such as numbers, letters, and marks and equivalents thereof. An example of the code is an identification number including a string of numbers and letters. The identification number is not a string of random symbols but a serial number. Thus, a plurality of banknotes may have consecutive identification numbers.

The identification number is printed on each banknote. For example, numbers and letters constituting the identification number are printed on the banknote.

The banknote handling system reads the identification number of each banknote when the matching process of the identification number is performed. The banknote handling system reads the identification number optically, electrically, or magnetically. The banknote handling system can read the identification number including a string of numbers or letters printed on the banknote by using an optical means, for example. The banknote handling system obtains information on symbols of the respective digits constituting the identification number. Since a technique of reading the identification number is known, the detailed description is omitted. The banknote handling system can employ known various techniques, as appropriate.

The banknote handling system performs matching of the identification number read from the banknote (i.e., a second code) with a reference identification number (i.e., a first code). The identification number read from the banknote is a target identification number to be subjected to matching. As mentioned above, the reference identification number may or may not be determined in advance. The banknote handling system determines whether or not the target identification number read from the banknote (i.e., the second code) matches with the reference identification number.

When the banknote handling system performs matching between the target identification number and the reference identification number, the banknote handling system compares symbols of the digits at the same positions. The number of digits in the target identification number is the same as the number of digits in the reference identification number. The banknote handling system determines a match or a mismatch of the symbols of digits at the respective positions.

If symbols of all digits match between the two identification numbers, the banknote handling system determines that the target identification number matches with the reference identification number.

The banknote handling system determines that the target identification number matches with the reference identification number even if there is a mismatch of symbols of some digits, but the number of mismatch digits is a predetermined number or less. This is because the accuracy of reading the identification number is not high.

The banknote handling system may not reliably and accurately read all digits of the identification number printed on the banknote due to dirt on the banknote, creases in the banknote, and/or various other factors. If the banknote handling system cannot read or erroneously reads some digits, the banknote handling system determines that the target identification number mismatches with the reference identification number even if all digits of the target identification number printed on the banknote match with those of the reference identification number.

On the other hand, if symbols of some digits of the target identification number match with those of the reference identification number, the banknote handling system determines that the target identification number matches with the reference identification number. If the number of digits for which a mismatch of symbols is allowed is appropriately set, the matching accuracy for the identification number does not decrease; on the contrary, the matching accuracy for the identification number increases. In the matching process, the number of digits for which a mismatch of symbols is allowed can be set appropriately. The positions of digits for which a mismatch of symbols is allowed can be basically any positions.

However, the present inventors realized that in the matching of the identification number on the banknote, the matching accuracy for the identification number is higher in the case where a mismatch of symbols of digits at specific positions is disallowed. In other words, in a novel matching method proposed by the present inventors, positions of digits for which a mismatch is allowed are not any positions, and if symbols of digits at specific conditions mismatch, the banknote handling system determines that the target identification number mismatches with the reference identification number even if symbols of other digits all match.

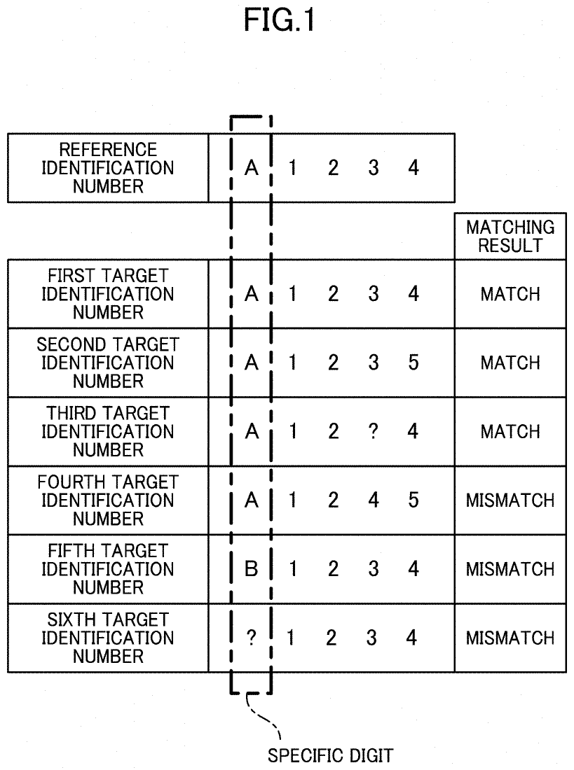

The above-mentioned matching method will be described in detail below with reference to FIG. 1. FIG. 1 is a diagram for illustrating the novel matching method. In this example, the reference identification number is “A1234.” In the matching of the identification number, the number of digits for which a mismatch of symbols is allowed is one. The number of digits for which a mismatch of symbols is disallowed is the highest digit. The digit for which a mismatch of symbols is disallowed is hereinafter referred to as a “specific digit.”

The banknote handling system determines that the target identification number matches with the reference identification number if the symbol of a specific digit of the target identification number matches with that of the reference identification number and if the number of digits for which symbols mismatch is a predetermined number or less, i.e., one digit or less in this example. The banknote handling system determines that the target identification number mismatches with the reference identification number if the symbol of a specific digit of the target identification number mismatches with that of the reference identification number. Further, the banknote handling system determines that the target identification number mismatches with the reference identification number if the number of digits for which symbols mismatch exceeds a predetermined number, i.e., the number of digits for which symbols mismatch exceeds one in this example.

The first to sixth target identification numbers illustrate identification numbers read from the banknotes to be handled, by the banknote handling system. The first target identification number is “A1234.” Symbols of all digits of the first target identification number match with those of the reference identification number. The banknote handling system determines that the first target identification number matches with the reference identification number.

The second target identification number is “A1235.” In the second target identification number, the number of the lowest digit differs from that of the reference identification number. The number of digits for which symbols mismatch is one. The symbol of the specific digit in the second target identification number matches with that of the reference identification number. Between the second target identification number and the reference identification number, symbols of specific digits all match and the number of digits for which symbols mismatch is a predetermined number or less. The banknote handling system determines that the second target identification number matches with the reference identification number.

The third target identification number is an example where some digits could not be read. Specifically, the banknote handling system could not read a symbol of the fourth digit from the highest digit. In FIG. 1, the digit for which the symbol could not be read is represented by “?” The banknote handling system handles the digit for which the symbol could not be read as a digit which mismatches with that of the reference identification number. In the third target identification number, the number of digits for which symbols mismatch is one. The symbol of the specific digit in the third target identification number matches with that of the reference identification number. Between the third target identification number and the reference identification number, symbols of specific digits all match and the number of digits for which symbols mismatch is a predetermined number or less. The banknote handling system determines that the third target identification number matches with the reference identification number.

The fourth target identification number is “A1245.” In the fourth target identification number, numbers of the fourth digit from the highest digit and the lowest digit differ from those of the reference identification number. The number of digits for which numbers mismatch is two. The number of digits for which numbers mismatch between the fourth target identification number and the reference identification number exceeds the predetermined number. The symbol of the specific digit in the fourth target identification number matches with that of the reference identification number. However, the banknote handling system determines that the fourth target identification number mismatches with the reference identification number.

The banknote handling system determines that the target identification number mismatches with the reference identification number also if the sum of the number of digits for which symbols mismatch between the target identification number and the reference identification number and the number of digits for which symbols could not be read by the banknote handling system exceeds a predetermined number. The banknote handling system determine that the target identification number mismatches with the reference identification number even if the number of digits for which symbols of the target identification number could not be read by the banknote handling system exceeds the predetermined number.

The fifth target identification number is “B1234.” In the fifth target identification number, the symbol of the highest digit differs from that of the reference identification number. The number of digits for which symbols mismatch is one. The digit for which the symbol mismatches is a specific digit. The banknote handling system determines that the fifth target identification number mismatches with the reference identification number.

The sixth target identification number is “?1234.” Specifically, the banknote handling system could not read the symbol of the highest digit. In the sixth target identification number, the symbol of the specific digit mismatches with that of the reference identification number. The banknote handling system determines that the sixth target identification number mismatches with the reference identification number.

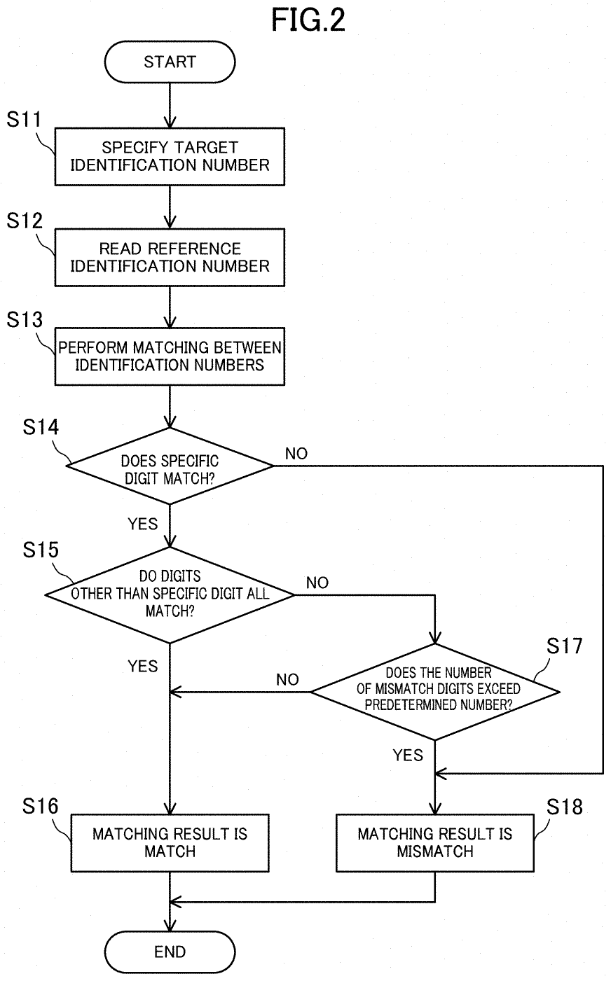

FIG. 2 is a flowchart related to the matching process performed by the banknote handling system. First, in step S11 after the start, the banknote handling system specifies a target identification number. The banknote handling system, for example, reads an identification number printed on a banknote.

In subsequent step S12, the banknote handling system reads a reference identification number. The reference identification number may be stored in, for example, a memory unit in advance.

In step S13, the banknote handling system performs matching between the target identification number and the reference identification number. In other words, the banknote handling system compares symbols of digits of the target identification number with those of the reference identification number.

In step S14, the banknote handling system determines whether or not symbols of specific digits of the target identification number match with those of the reference identification number. If the answer is YES in step S14, the process proceeds to step S15. If the answer is NO in step S14, the process proceeds to step S18.

In step S18, the banknote handling system determines that the target identification number mismatches with the reference identification number. As mentioned above, in this matching method, if symbols of specific digits mismatch, the target identification number mismatches with the reference identification number.

In step S15, the banknote handling system determines whether or not all symbols of digits other than the specific digits of the target identification number match with those of the reference identification number. If the answer is YES in step S15, i.e., symbols of all digits of the target identification number match with those of the reference identification number, the process proceeds to step S16. In step S16, the banknote handling system determines that the target identification number matches with the reference identification number.

If the answer is NO is step S15, the process proceeds to step S17. In step S17, the banknote handling system determines whether or not the number of digits for which symbols mismatch exceeds the predetermined number. If the number exceeds the predetermined number, the process proceeds to step S18. If the number does not exceed the predetermined number, the process proceeds to step S16. Specifically, if the number of digits for which symbols mismatch is the predetermined number or less, the banknote handling system determines that the target identification number matches with the reference identification number in step S16, and if the number of digits for which symbols mismatch exceeds the predetermined number, the banknote handling system determines that the target identification number mismatches with the reference identification number in step S18.

In the matching process of the identification numbers, the number of digits for which a mismatch of symbols is allowed is not limited to one. The number of digits for which a mismatch of symbols is allowed may be two or more. However, if the number of digits for which a mismatch of symbols is allowed is too large, the matching accuracy for the identification number decreases. The number of digits for which a mismatch of symbols is allowed may be set to one or several digits.

In the matching process of the identification numbers, the number of specific digits is not limited to one. The banknote handling system may set two or more specific digits and perform matching of the identification numbers. The two or more specific digits may be in a row (i.e., adjacent to each other) or may be apart from each other.

In the matching method disclosed herein, the relational expression X>Y+Z is established between X, Y, and Z, where the number of digits of the identification number is X, the number of digits for which a mismatch of symbols is allowed is Y, and the number of specific digits is Z. As mentioned above, Y and Z can be set to any numbers. In addition, Y and Z may be set according to the attribute of the banknote to be subjected to matching. Alternatively, Y and Z may be set according to the types of symbols (i.e., letters, numbers, and marks) of digits of the identification number.

As mentioned above, the positions of specific digits may be set to any positions. The positions of the specific digits may be set according to the attribute of the banknote to be subjected to matching. The positions of the specific digits may be set according to the type of symbols (i.e., letters, numbers, and marks) of digits of the identification number. The specific digits include at least one digit for any type of symbols.

In a case where the number of digits of the target identification number differs from that of the reference identification number, the banknote handling system may add the difference in the number of digits to digits for which symbols mismatch. In a case where the number of digits of the target identification number differs from that of the reference identification number, the banknote handling system may determine that the identification number mismatches.

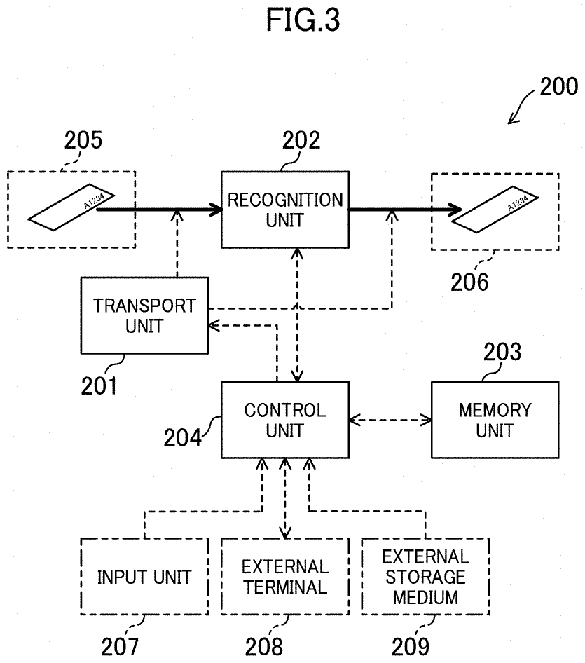

FIG. 3 illustrates a specific example configuration of a banknote handling system 200. The banknote handling system 200 includes a transport unit 201, a recognition unit 202, a memory unit 203, and a control unit 204.

The transport unit 201 transports banknotes one by one from a transport source 205 to a transport destination 206. The transport unit 201 has a transport path (see arrows indicated by a thick solid line in FIG. 3) connecting between the transport source 205 and the transport destination 206. The transport unit 201 transports banknotes along the transport path.

The transport unit 201 may transport banknotes in one direction or both directions. The transport path may have an endless loop shape. The transport unit 201 may transport banknotes in one direction or both directions along the endless loop-shaped transport path.

The transport source 205 may be one or more. The transport unit 201 may transport banknotes from one transport source 205 selected from a plurality of transport sources 205 to a transport destination 206. The transport destination 206 may be one or more. The transport unit 201 may transport banknotes from the transport source 205 to one transport destination 206 selected from a plurality of transport destinations 206. The transport unit 201 may transport banknotes from one transport source 205 selected from a plurality of transport sources 205 to one transport destination 206 selected from a plurality of transport destinations 206. The transport unit 201 may transport banknotes to one transport destination 206 selected from a plurality of transport destinations 206 in accordance with a recognition result from the recognition unit 202 to be described later. The transport source 205 includes a deposit unit, a temporary storage unit, and a storage unit, which will be described later. The transport destination 206 includes a storage unit, a dispense unit, a temporary storage unit, and a reject unit, which will be described later. For example, there are cases where the storage unit is the transport source 205 and the storage unit is the transport destination 206, in accordance with the direction in which banknotes are transported.

The recognition unit 202 is provided between the transport source 205 and the transport destination 206. The recognition unit 202 is provided in the middle of the transport path. The recognition unit 202 reads the identification numbers of the banknotes transported by the transport unit 201. The identification numbers read by the recognition unit 202 are identification numbers to be subjected to matching, i.e., target identification numbers. The recognition unit 202 outputs information on the identification numbers to the control unit 204.

The recognition unit 202 may recognize various pieces of information on the banknotes. The recognition unit 202 may recognize information on at least one of currency, denomination, authentication, or fitness of each banknote, for example.

The recognition unit 202 is a recognition circuit that includes at least one sensor. The recognition circuit comprises a timing sensor, an optical line sensor configured to apply a plurality of light rays such as infrared rays and visible rays to determine the optical properties of the banknotes and obtain optical image information of the banknotes, a thickness detection sensor configured to determine the thickness of the banknotes, and a magnetic sensor configured to determine the magnetic properties of the banknotes.

The memory unit 203 stores information on the reference identification number, for example. The memory unit 203 includes a non-volatile memory such as a hard disk drive, a solid state drive (SSD), and a flash memory. The memory unit 203 outputs information on the reference identification number to the control unit 204. The memory unit 203 may store the reference identification number. The memory unit 203 may further store the attribute of the banknote corresponding to the reference identification number. The attribute of the banknote is, for example, currency and/or denomination. The memory unit 203 may store images of the banknotes including the reference identification number. The reference identification number is obtained by subjecting the images to OCR processing. The memory unit 203 further stores information on a specific digit. The memory unit 203 outputs information on the specific digit to the control unit 204.

The control unit 204 performs matching between two identification numbers. The control unit 204 is connected to the recognition unit 202. The control unit 204 receives information on the target identification number output from the recognition unit 202. The control unit 204 is connected to the memory unit 203. The control unit 204 receives information on the reference identification number and information on the specific digit, output from the memory unit 203. The control unit 204 performs a matching process in accordance with procedures shown in the flowchart of FIG. 2 based on these pieces of information.

The control unit 204 controls transport of banknotes through the transport unit 201. As mentioned above, the control unit 204 may control the transport unit 201 in accordance with the recognition result and/or the matching result. For example, the control unit 204 may select a transport destination for a banknote in accordance with the matching result. The control unit 204 may transport the next banknote from the transport source in accordance with the matching result. The control unit 204 may select the transport source of the next banknote in accordance with the matching result.

The banknote handling system 200 may further include an output unit that outputs the matching result. The output unit may be connected to the control unit 204. The output unit may be a display unit that displays the matching result to the user. The display unit may be a flat panel display, for example. The output unit may be a communication unit which transmits the matching result to the outside of the banknote handling system. The communication unit performs communication through a wired or wireless communication line. The output unit may be a printing unit that prints the matching result. Various systems such as an inkjet system or a thermal transfer system can be employed as the system for the printing unit.

The transport unit 201, the recognition unit 202, the memory unit 203, and the control unit 204 may be assembled to a housing to constitute a single machine. Some of the transport unit 201, the recognition unit 202, the memory unit 203, and the control unit 204 may be assembled to a housing to constitute a single machine, and the other components may be provided separately from the machine. Some components may be communicably connected to the other components.

The other components may include, for example, a memory unit. The number of memory units is not limited to one, and may be more than one. Some of the memory units may be separate from the machine. The memory unit separate from the machine is a so-called external memory unit. The external memory unit may store information on the reference identification number described above.

Other components may include, for example, a control unit. The control unit may be divided into a control unit that performs matching of the identification numbers and a control unit that performs control of the transport unit. The control unit that performs matching of the identification numbers may be separate from the machine.

As mentioned above, the memory unit 203 may store information on the specific digit. Information on the specific digit may be incorporated into software in the control unit 204.

As shown in the two-dot chain line of FIG. 3, the banknote handling system 200 may include an input unit 207. The input unit 207 may be an operation unit that inputs information on the specific digit to the control unit 204 in accordance with the operation by the user. The input unit 207 may also be a communication unit that receives a signal from the outside of the banknote handling system. The external terminal 208 may be connectable to the communication unit of the banknote handling system 200. The external terminal 208 inputs information on the specific digit to the control unit 204 via communication. An external storage medium 209 may be connectable to the banknote handling system 200. The external storage medium 209 may be a portable medium, such as a USB memory, for example. The external storage medium 209 stores information on the specific digit. The control unit 204 obtains information on the specific digit from the external storage medium 209.

(Method of Setting Specific Digit)

The identification number of a banknote is usually a number representing the serial number of the banknote. Numbers, letters, and marks constituting the identification number are arranged according to a specific rule. In other words, in the identification number, the number and positions of digits for numbers and the number and positions of digits for letters are determined. In the following description, properties determined by the number and positions of digits for numbers and the number and positions of digits for letters may be referred to as characteristics of the identification number.

The number and positions of specific digits may be set according to arrangement of numbers, letters, and marks constituting the identification number. For example, some or all digits of numbers in a string may be specific digits. For example, some or all digits of letters in a string may be specific digits.

The specific rule related to the identification number is determined for each currency, for example. The number and positions of specific digits may be set in advance in association with the currency of the banknote. The control unit of the banknote handling system may set the number and positions of specific digits based on the currency of the banknote to be subjected to matching when the matching process of the identification number is performed.

The specific rule related to the identification number is determined for each denomination, for example. The number and positions of specific digits may be set in advance in association with the denomination of the banknote. The control unit may set the number and positions of specific digits in association with the denomination based on the denomination of the banknote to be subjected to matching when the matching process of the identification number is performed.

In other words, the control unit may set the specific digit based on the attribute of the banknote to be subjected to matching.

The control unit can obtain information on the attribute of the banknote to be subjected to matching based on input signals from various elements. In other words, the control unit can obtain information on the currency and information on the denomination based on the input signals. The control unit can set the number and positions of the specific digits based on the information on the currency and/or the information on the denomination obtained.

As mentioned above, the recognition unit may recognize the currency and denomination of the banknote, i.e., the attribute of the banknote. The recognition unit outputs a signal related to the currency and denomination of the banknote to the control unit. The memory unit may store information on the currency and denomination of the banknote to be subjected to matching. The memory unit outputs a signal related to the currency and denomination of the banknote to the control unit. The information on the currency and denomination may be incorporated into software in the control unit.

The user may input the information on the attribute of the banknote, i.e., the information on the currency and the denomination of the banknote, to the input unit. The input unit outputs a signal related to the currency and denomination, to the control unit. The external terminal may output the signal related to the currency and denomination, to the control unit. The control unit may obtain information on the currency and denomination from an external storage medium.

In a case where each of a plurality of transport sources correspond to the attribute (i.e., the currency and the denomination) of banknote transported from the respective transport sources, the control unit may obtain information on the currency and denomination of the banknote based on the transport source of the banknote to be subjected to matching. For example, it is assumed that the transport sources are storage units that store banknotes, and each storage unit stores banknotes of the same attribute, i.e., the same currency and/or denomination. The storage unit corresponds to the attribute of the banknotes fed out from the storage unit. Thus, the control unit can set the number and positions of specific digits based on the storage unit from which the banknotes to be subjected to matching are fed out.

The number and positions of the specific digits may be set based on a characteristic of the target identification number. The number and positions of the specific digits may be set based on a characteristic of the reference identification number.

The matching process is performed in accordance with various processes performed by the banknote handling system. For example, during the depositing process, the banknote handling system performs a matching process of the identification number to extract a counterfeit note. For example, during a reconciliation process, the banknote handling system performs a matching process of the identification numbers to specify the banknotes fed out from the storage unit. The number and positions of specific digits may be set according to the type of process performed by the banknote handling system.

The number and positions of specific digits may be set according to characteristics of the identification numbers read from the banknotes. Accordingly, the banknote handling system can set the number and positions of specific digits corresponding to the banknotes to be subjected to matching. This configuration is effective when the banknote handling system performs matching of a plurality of types of banknotes having different characteristics of the identification numbers. Specifically, the banknote handling systems of the same configuration may be installed in various countries with different currencies. The banknote handling system can set the number and positions of specific digits corresponding to the currency of the banknote to be subjected to matching in accordance with the characteristics of the identification number read from the banknote. The method of setting positions of the specific digits in accordance with characteristics of the identification number read from the banknote will be described in detail below.

(Specific Example of Matching Process in Depositing Process)

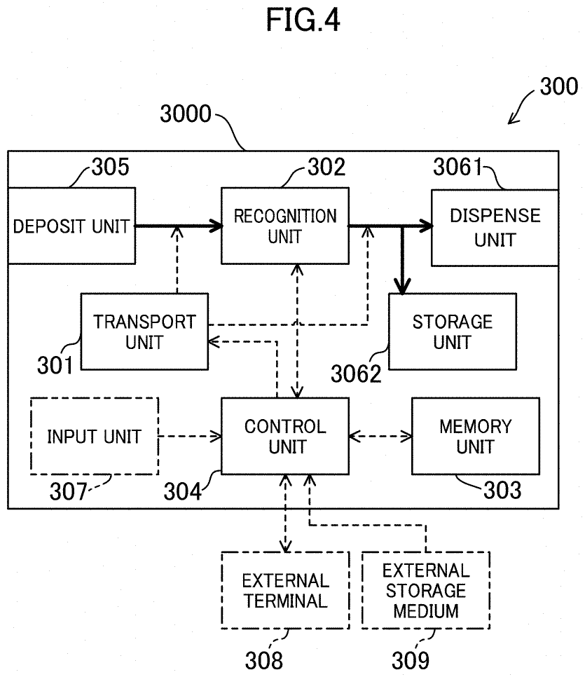

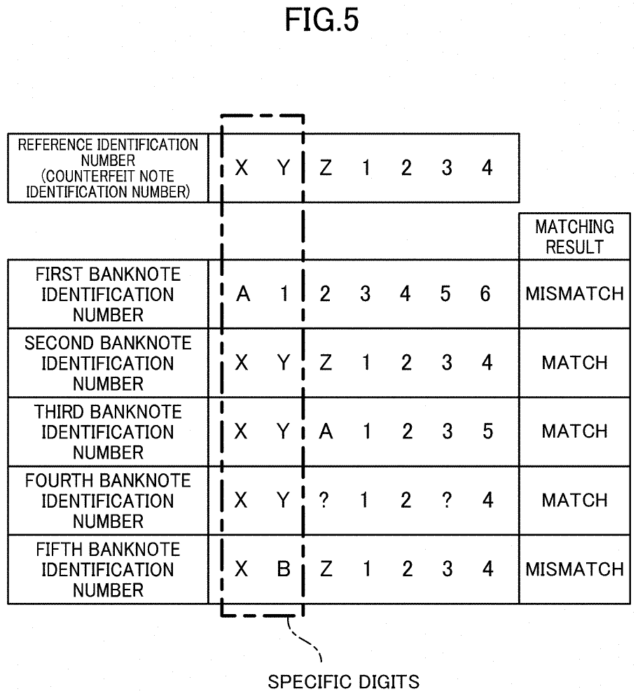

Next, a specific example of the matching process of the identification numbers, performed during the depositing process will be described below with reference to FIGS. 4 and 5. As mentioned above, the transport source 205 of the banknote handling system 200 illustrated in FIG. 3 may be a deposit unit. As mentioned above, the transport destination 206 of the banknote handling system 200 may be a dispense unit and a storage unit. FIG. 4 illustrates a banknote handling system 300 as an example configuration of the banknote handling system 200 of FIG. 3. The banknote handling system 300 extracts a counterfeit note and a banknote suspected to be a counterfeit note by performing a matching process of the identification numbers during the depositing process.

The banknote handling system 300 includes a transport unit 301, a recognition unit 302, a memory unit 303, a control unit 304, a deposit unit 305, a dispense unit 3061, and a storage unit 3062. In the banknote handling system 300 of FIG. 4, the transport unit 301, the recognition unit 302, the memory unit 303, the control unit 304, the deposit unit 305, the dispense unit 3061, and the storage unit 3062 are assembled to the housing 3000 to constitute a single machine. As mentioned above, some components may be provided separately from the machine.

The transport unit 301 transports the banknotes from the deposit unit 305 to the dispense unit 3061 or the storage unit 3062. The transport unit 301 has a transport path (see an arrow indicated by a thick solid line in FIG. 4) connecting the deposit unit 305, the dispense unit 3061, and the storage unit 3062 with one another.

The deposit unit 305 is an example of the transport source. The user can manually insert a banknote to be deposited in the deposit unit 305. The deposit unit 305 keeps the banknote inserted. The dispense unit 3061 and the storage unit 3062 are examples of the transport destination. The transport unit 301 transports a genuine note among banknotes to be deposited, to the storage unit 3062. The storage unit 3062 stores banknotes. The transport unit 301 transports a counterfeit note or a banknote suspected to be a counterfeit note to the dispense unit 3061. The dispense unit 3061 keeps banknotes. The user can manually remove the banknotes kept in the dispense unit 3061. The transport unit 301 may transport a counterfeit note or a banknote suspected to be a counterfeit note to a storage unit 3062 different from the storage unit storing a genuine note. The storage unit 3062 may feed out the banknotes stored. The storage unit 3062 may be a transport destination.

The recognition unit 302 at least recognizes currency, denomination, and authentication of each banknote. Based on the recognition result, the control unit 304 can count the number of banknotes to be deposited and the total amount of money. The recognition unit 302 also reads an identification number printed on the banknote. The recognition unit 302 outputs a signal related to the identification number to the control unit 304.

The memory unit 303 stores a reference identification number. The reference identification number is an identification number of a counterfeit note in this example configuration. The counterfeit note may have a characteristic in the identification number. For example, the characteristic may be that the digit at a specific position is the same letter or the same number. FIG. 5 illustrates a reference identification number. The “XYZ1234” illustrated in FIG. 5 is an identification number of a counterfeit note. The counterfeit note is characterized in that the highest digit and the second digit from the highest digit of the identification number are “XY” The highest digit and the second digit from the highest digit are set as specific digits.

The banknote handling system 300 performs a depositing process. The depositing process is a process of counting banknotes inserted into the deposit unit 305 and storing them in the storage unit 3062. The control unit 304 performs a matching process of the identification numbers at the time of the depositing process. The control unit 304 performs the matching process in accordance with a flowchart of FIG. 2, for example. By the matching process, the control unit 304 extracts a counterfeit note and a banknote suspected to be a counterfeit note from among banknotes to be deposited.

The matching process performed by the control unit 304 will be described in detail below with reference to FIG. 5. As mentioned above, the reference identification number is “XYZ1234,” and specific digits are two digits, i.e., the highest digit and the second digit from the highest digit. In the matching process, the control unit 304 allows a mismatch of symbols of up to two digits. In step S17 of the flowchart of FIG. 2, the predetermined number is two.

The first to the fifth banknote identification numbers show identification numbers, i.e., target identification numbers, read by the recognition unit 302. The first banknote identification number is “A123456.” Symbols of all digits of the first banknote identification number differ from those of the reference identification number. The control unit 304 determines that the first banknote identification number mismatches with the reference identification number. It is determined that the banknote having the first banknote identification number is not a counterfeit note.

The second banknote identification number is “XYZ1234.” Symbols of all digits of the second banknote identification number match with those of the reference identification number. The control unit 304 determines that the second banknote identification number matches with the reference identification number. It is determined that the banknote having the second banknote identification number is a counterfeit note or a banknote suspected to be a counterfeit note.

The third banknote identification number is “XYA1235.” Symbols of two digits of the third banknote identification number differ from those of the reference identification number. Symbols of the specific digits of the third banknote identification number match with those of the reference identification number. The banknote handling system 300 determines that the third banknote identification number matches with the reference identification number. It is determined that the banknote having the third banknote identification number is a counterfeit note or a banknote suspected to be a counterfeit note. Even in the case where the banknotes have identification numbers which do not fully match with the reference identification number, the banknote handling system 300 can extract a counterfeit note or a banknote suspected to be a counterfeit note based on the specific digits.

The fourth banknote identification number is “XY?12?4.” In the fourth banknote identification number, symbols of the third and sixth digits are not read. Symbols of two digits of the fourth banknote identification number differ from those of the reference identification number. Symbols of the specific digits of the fourth banknote identification number match with those of the reference identification number. The banknote handling system 300 determines that the fourth banknote identification number matches with the reference identification number. It is determined that the banknote having the fourth banknote identification number is a counterfeit note or a banknote suspected to be a counterfeit note. Even if part of the identification number cannot be read, the banknote handling system 300 can extract a counterfeit note or a banknote suspected to be a counterfeit note based on the match of symbols of the specific digits.

The fifth banknote identification number is “XBZ1234.” Only the symbol of the second digit from the highest digit of the fifth banknote identification number differs from that of the reference identification number. The fifth banknote identification number matches with the reference identification number if reference is made to only the number of digits for which symbols mismatch. However, symbols of the specific digits of the fifth banknote identification number are different from those of the reference identification number. The banknote handling system 300 determines that the fifth banknote identification number mismatches with the reference identification number. The banknote handling system 300 can accurately extract a counterfeit note or a banknote suspected to be a counterfeit note based on the specific digits.

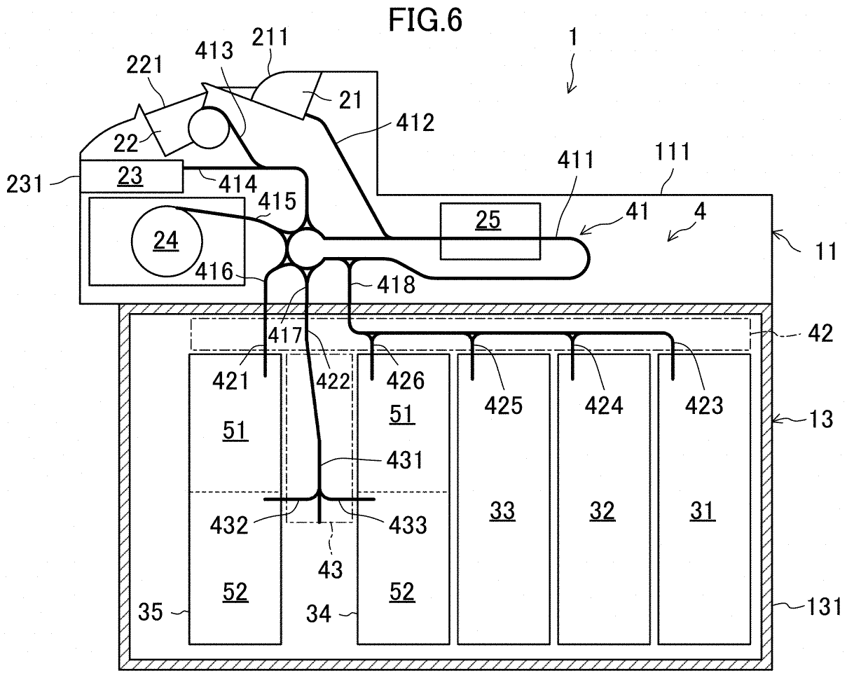

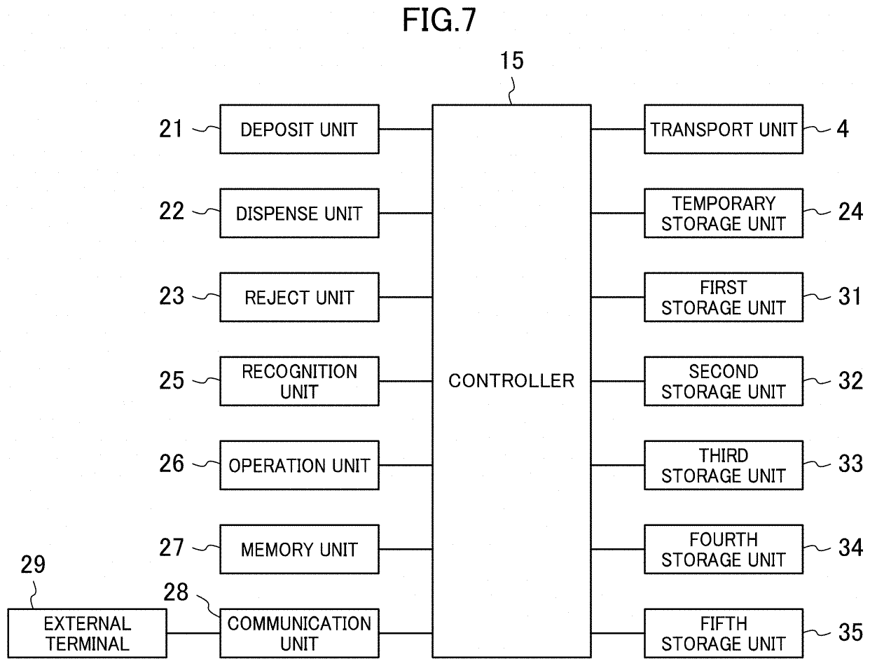

As mentioned above, the transport source 205 of the banknote handling system 200 illustrated in FIG. 3 may be a deposit unit and a temporary storage unit. The transport destination 206 of the banknote handling system 200 may be the dispense unit, the storage unit, the temporary storage unit, or the reject unit. The banknote handling system 200 may further include an operation unit, a communication unit, and an external terminal. FIGS. 6 and 7 illustrate a banknote handling system as an example configuration of the banknote handling system 200 of FIG. 3. The banknote handling system constitutes a banknote handling machine 1 by assembling components into a housing. The banknote handling machine 1 performs various processes including a depositing process and a dispensing process. The depositing process is a process of storing banknotes to be deposited in the storage unit as mentioned above. The dispensing process is a process of dispensing banknotes to be dispensed from the storage unit to the outside of the banknote handling machine 1.

FIG. 6 schematically illustrates an internal configuration of the banknote handling machine 1. FIG. 7 is a block diagram illustrating a configuration of the banknote handling machine 1. The banknote handling machine 1 includes an upper handling unit 11 and a lower safe unit 13. The handling unit 11 is comprised of an upper housing 111. In the upper housing 111, a deposit unit 21, a dispense unit 22, a reject unit 23, a temporary storage unit 24, a recognition unit 25, and an upper transport unit 41 are disposed. The upper transport unit 41 is a part of a transport unit 4.

The safe unit 13 is comprised of a safe housing 131. In the safe housing 131, a plurality of storage units 31 to 35, a lower transport unit 42, and a second lower transport unit 43 are disposed. The lower transport unit 42 and the second lower transport unit 43 are a part of the transport unit 4. The safe housing 131 protects the storage units 31 to 35 at a security level equal to or higher than a predetermined level. Specifically, the safe housing 131 is comprised of a metal board of a thickness equal to or higher than a predetermined thickness. The security level of the safe housing 131 is higher than that of the upper housing 111.

The deposit unit 21 is a portion of the machine into which the banknotes to be deposited are placed, for example, in a depositing process. The deposit unit 21 has the inlet 211. The user manually inserts the banknotes into the deposit unit 21 via the inlet 211. The deposit unit 21 is capable of holding a plurality of banknotes while the banknotes are stacked. The deposit unit 21 has a mechanism that takes the banknotes one by one into the banknote handling machine 1.

The dispense unit 22 is a portion of the machine to which banknotes fed from the storage unit are transported, for example, in a dispensing process. The dispense unit 22 is capable of holding a plurality of banknotes while the banknotes are stacked. The dispense unit 22 has the outlet 221. The user can manually remove the banknotes stacked in the dispense unit 22 through the outlet 221.

The reject unit 23 is a portion of the machine to which banknotes rejected, for example, in a depositing process, are transported. The reject unit 23 is configured to hold a plurality of banknotes while the banknotes are stacked. The reject unit 23 has a second outlet 231. The second outlet 231 is provided with a shutter. When the shutter opens, the user can remove the banknotes stacked in the reject unit 23 through the second outlet 231.

The temporary storage unit 24 temporarily stores the banknotes to be deposited, for example, in the depositing process. The temporary storage unit 24 can feed the stored banknotes. The temporary storage unit 24 is a tape-winding storage unit. The temporary storage unit 24 stores the banknotes by wrapping them around a drum together with a tape. The tape-winding storage unit is advantageous because the order of banknotes does not change when the banknotes are stored and fed. Further the tape-winding storage unit is also advantageous because it is capable of storing mixed banknotes of various sizes. A known configuration of the tape-winding storage unit may be employed as the temporary storage unit 24.

The recognition unit 25 is disposed in a first transport path 411. For each of the banknotes being transported through the first transport path 411, the recognition unit 25 recognizes at least the currency, the authentication, the denomination, and the fitness. The recognition unit 25 also reads an identification number printed on the banknote.

The banknote handling machine 1 includes a first storage unit 31, a second storage unit 32, a third storage unit 33, a fourth storage unit 34, and a fifth storage unit 35.

The first storage unit 31, the second storage unit 32, and the third storage unit 33 have the same configuration. The first storage unit 31, the second storage unit 32, and the third storage unit 33 are each a stack-type storage unit. The stack-type storage unit stores the banknotes in a stacked manner. The first storage unit 31, the second storage unit 32, and the third storage unit 33 each have a single storage region. The first storage unit 31, the second storage unit 32, and the third storage unit 33 each store banknotes in the storage region and feed out banknotes from the storage region. The first storage unit 31, the second storage unit 32, and the third storage unit 33 are each configured to feed out banknotes by a first-in last-out method.

The fourth storage unit 34 and the fifth storage unit 35 have the same configuration. The fourth storage unit 34 and the fifth storage unit 35 are each a stack-type storage unit. The fourth storage unit 34 and the fifth storage unit 35 each have a first storage region 51 and a second storage region 52. The first storage region 51 is provided on an upper side. The second storage region 52 is provided on a lower side of the first storage region 51. The first storage region 51 and the second storage region 52 are independent from each other. The fourth storage unit 34 and the fifth storage unit 35 each include a first transport mechanism for the first storage region 51 and a second transport mechanism for the second storage region 52. The fourth storage unit 34 and the fifth storage unit 35 can each store banknotes in the first storage region 51 and feed out banknotes from the first storage region 51, and can each store banknotes in the second storage region 52 and feed out banknotes from the second storage region 52. The fourth storage unit 34 and the fifth storage unit 35 are also configured to feed out banknotes stored by a first-in last-out method.

The configuration of the storage unit illustrated in FIG. 6 is a mere example, and the number of storage units housed in the safe housing 131, the arrangement of the storage units, and the structure of each of the storage units are not limited to those shown in the configuration of FIG. 6.

The transport unit 4 is a transport member which transports the banknotes one by one at intervals in the banknote handling machine 1. The transport unit 4 has a transport path. The transport path is comprised of a combination of a large number of rollers, a plurality of belts, a motor for driving the rollers, and a plurality of guides. The transport unit 4 transports the banknotes, for example, with their long edges facing forward. The transport unit 4 may transport the banknotes with their short edges facing forward.

The transport unit 4 includes the upper transport unit 41, the lower transport unit 42, and the second lower transport unit 43. The upper transport unit 41 is disposed in the upper housing 111, as mentioned above. The lower transport unit 42 and the second lower transport unit 43 are disposed in the safe housing 131. Three transport paths pass through an upper wall defining the safe housing 131 in the up-down direction. The three transport paths connect, respectively, a sixth transport path 416 with a ninth transport path 421, a seventh transport path 417 with a tenth transport path 422, and an eighth transport path 418 with an eleventh transport path 423, which will be described later.

The upper transport unit 41 includes the first transport path 411, a second transport path 412, a third transport path 413, a fourth transport path 414, a fifth transport path 415, the sixth transport path 416, the seventh transport path 417, and the eighth transport path 418.

The first transport path 411 is formed in an endless loop shape. The transport unit 4 transports the banknotes along the first transport path 411 in a clockwise direction and a counterclockwise direction in FIG. 1.

The second transport path 412 connects the deposit unit 21 and the first transport path 411 together. The second transport path 412 transports the banknotes from the deposit unit 21 toward the first transport path 411.

The third transport path 413 connects the dispense unit 22 and the first transport path 411 together. The third transport path 413 transports the banknotes from the first transport path 411 toward the dispense unit 22. A junction between the third transport path 413 and the first transport path 411 is provided with a diverter for changing the destination of the banknotes.

The fourth transport path 414 connects the reject unit 23 and an intermediate location of the third transport path 413 with each other. The fourth transport path 414 transports the banknotes from the third transport path 413 toward the reject unit 23. A junction between the fourth transport path 414 and the third transport path 413 is provided with a diverter.

The fifth transport path 415 connects the temporary storage unit 24 and the first transport path 411 together. The fifth transport path 415 transports the banknotes from the first transport path 411 toward the temporary storage unit 24 and from the temporary storage unit 24 toward the first transport path 411. A junction between the fifth transport path 415 and the first transport path 411 is provided with a diverter.

The sixth transport path 416 connects the lower transport unit 42 and the first transport path 411 together. The sixth transport path 416 transports the banknotes from the first transport path 411 toward the lower transport unit 42 and from the lower transport unit 42 toward the first transport path 411. A junction between the sixth transport path 416 and the first transport path 411 is provided with a diverter.

Similarly to the sixth transport path 416, the seventh transport path 417 connects the lower transport unit 42 and the first transport path 411 together. The seventh transport path 417 transports the banknotes from the first transport path 411 toward the lower transport unit 42 and from the lower transport unit 42 toward the first transport path 411. A junction between the seventh transport path 417 and the first transport path 411 is provided with a diverter.

The eighth transport path 418 connects the lower transport unit 42 and the first transport path 411 together. The eighth transport path 418 transports the banknotes from the first transport path 411 toward the lower transport unit 42 and from the lower transport unit 42 toward the first transport path 411. A junction between the eighth transport path 418 and the first transport path 411 is provided with a diverter.

The lower transport unit 42 is disposed above the first to fifth storage units 31 to 35. The lower transport unit 42 includes a ninth transport path 421, a tenth transport path 422, and an eleventh transport path 423. The lower transport unit 42 is configured as one unit which includes the ninth transport path 421, the tenth transport path 422, and the eleventh transport path 423.

The ninth transport path 421 connects the first storage region 51 of the fifth storage unit 35 and the sixth transport path 416 together. The ninth transport path 421 transports the banknotes from the sixth transport path 416 toward the first storage region 51 of the fifth storage unit 35 and from the first storage region 51 of the fifth storage unit 35 toward the sixth transport path 416.

The tenth transport path 422 connects the second lower transport unit 43 and the seventh transport path 417 together. The tenth transport path 422 transports the banknotes from the seventh transport path 417 toward the second lower transport unit 43 and from the second lower transport unit 43 toward the seventh transport path 417.

The eleventh transport path 423 connects each of the first storage unit 31, the second storage unit 32, the third storage unit 33, and the first storage region 51 of the fourth storage unit 34 with the eighth transport path 418. The eleventh transport path 423 transports banknotes from the eighth transport path 418 to the storage units 31 to 34, and transports banknotes from the storage units 31 to 34 to the eighth transport path 418. More specifically, the end of the eleventh transport path 423 is connected to the first storage unit 31. The eleventh transport path 423 includes three branches: first to third branches 424, 425, and 426. The first branch 424 is connected to the second storage unit 32. The second branch 425 is connected to the third storage unit 33. The third branch 426 is connected to the first storage region 51 of the fourth storage unit 34. Junctions of the branches 424, 425, and 426 are provided with diverters.

The second lower transport unit 43 is disposed between the fourth storage unit 34 and the fifth storage unit 35. The second lower transport unit 43 includes a twelfth transport path 431. The twelfth transport path 431 connects the second storage region 52 of the fourth storage unit 34 and the second storage region 52 of the fifth storage unit 35 with the tenth transport path 422 of the lower transport unit 42. The twelfth transport path 431 includes a fourth branch 432 and a fifth branch 433. The fourth branch 432 is connected to the second storage region 52 of the fifth storage unit 35. The fifth branch 433 is connected to the second storage region 52 of the fourth storage unit 34. Junctions of the fourth branch 432 and the fifth branch 433 are provided with diverters.

Each position of the first to twelfth transport paths 411 to 418, 421 to 426, and 431 to 433 is provided with a tracking sensor for detecting passing of banknotes. Upon receipt of a command from a controller 15 to be described later, the transport unit 4 controls the diverters based on detection signals from the tracking sensor to transport banknotes to a predetermined destination.

As shown in FIG. 7, the banknote handling machine 1 includes the controller 15. The controller 15 is an example of the control unit. The controller 15 can include a central processing unit (CPU), a memory, and an I/O circuit. The CPU executes a program. The memory stores programs and data for the operation of the banknote handling machine 1. The memory is, for example, a random access memory (RAM) and/or a read only memory (ROM). The I/O circuit performs input and output of an electric signal between the controller 15 and each device connected to the controller 15. The controller 15 is connected so as to be capable of exchanging signals with each of the deposit unit 21, the dispense unit 22, the reject unit 23, the temporary storage unit 24, the recognition unit 25, the transport unit 4, the first storage unit 31, the second storage unit 32, the third storage unit 33, the fourth storage unit 34, and the fifth storage unit 35.

The banknote handling machine 1 includes an operation unit 26 operated by an user, a memory unit 27 for storing various pieces of data or the like, and a communication unit 28 for establishing communication with an external terminal 29. The operation unit 26, the memory unit 27, and the communication unit 28 are connected to the controller 15 so as to be capable of exchanging signals with the controller 15. The operation unit 26 may be configured by, for example, a touch panel display. The operation unit 26 is an example of the input unit. The external terminal 29 is provided separately from the banknote handling machine 1. The user operates the external terminal 29 to perform various processes performed by using the banknote handling machine 1.

The memory unit 27 stores information on the banknotes stored in the first storage unit 31, the second storage unit 32, the third storage unit 33, the fourth storage unit 34, and the fifth storage unit 35. The memory unit 27 specifically stores the number of banknotes stored in each storage unit, the denomination of the banknotes, and the total amount of the banknotes. The memory unit 27 stores the identification numbers of the respective banknotes stored in each storage unit. The memory unit 27 stores the identification numbers in order in which the banknotes are stored. Information in which the order in which banknotes are stored and the identification numbers are associated with each other may also be referred to as an identification number list hereinafter.

When the user operates the operation unit 26 or the external terminal 29, the controller 15 controls the deposit unit 21, the dispense unit 22, the reject unit 23, the temporary storage unit 24, the recognition unit 25, the transport unit 4, the first storage unit 31, the second storage unit 32, the third storage unit 33, the fourth storage unit 34, and the fifth storage unit 35 so that various processes be performed. It will be described below how the banknote handling machine 1 perform various processes with reference to the drawings.

(Depositing Process)

During the depositing process, the banknote handling machine 1 stores banknotes in the storing unit. The user inserts the banknotes to be deposited into the deposit unit 21. The deposit unit 21 takes the banknotes one by one into the machine. The transport unit 4 transports the banknotes to the recognition unit 25. The recognition unit 25 recognizes the banknote. The recognition unit 25 also reads identification numbers from the banknotes. The transport unit 4 transports the banknotes to the first storage unit 31, the second storage unit 32, the third storage unit 33, the fourth storage unit 34, or the fifth storage unit 35, in accordance with the recognition results of the recognition unit 25. The storage units 31 to 35 store banknotes. The transport unit 4 transports the banknotes recognized by the recognition unit 25 as banknotes to be rejected to the reject unit 23.

When all the banknotes inserted into the deposit unit 21 are taken into the banknote handling machine 1, the external terminal 29, for example, shows the deposited amount. The depositing process ends when the user operates the external terminal 29 or the operation unit 26 to confirm the depositing process.

The controller 15 stores the data related to the banknotes stored in the storage units 31 to 35 in the memory unit 27. The memory unit 27 stores the identification numbers read from the banknotes by the recognition unit 25, for each storage unit in order in which the banknotes are stored. The memory unit 27 updates and stores the identification number list for each storage unit each time the depositing process is performed. The identification number list stored in the memory unit 27 reflects the latest storage condition of each storage unit.

The banknote handling machine 1 further performs a replenishing process of replenishing each storage unit with banknotes. The operation of the banknote handling machine 1 during the replenishing process is similar to that during the depositing process.

During the depositing process and the replenishing process, the banknote handling machine 1 may perform a matching process of extracting a counterfeit note in accordance with the flowchart of FIG. 2. The counterfeit note or the banknote suspected to be a counterfeit note extracted is stored in the reject unit 23, for example.

(Dispensing Process)

During dispensing process, the banknote handling machine 1 dispenses the banknotes to the outside of the banknote handling machine 1. The storage units 31 to 35 feed the banknotes to be dispensed. The transport unit 4 transports the banknotes to the recognition unit 25. The recognition unit 25 recognizes the banknotes. The transport unit 4 transports the banknotes after recognition to the dispense unit 22. The dispense unit 22 keeps the banknotes to be dispensed. The transport unit 4 transports the banknotes recognized by the recognition unit 25 as banknotes to be rejected to the reject unit 23. The reject unit 23 stores the rejected banknotes. The dispensing process ends when all the banknotes to be dispensed are dispensed to the dispense unit 22.

The controller 15 deletes, from the memory unit 27, the data related to the banknotes fed from the storage units 31 to 35. The memory unit 27 deletes, from the identification number list, identification numbers read from the banknotes by the recognition unit 25. The memory unit 27 updates and stores the identification number list for each storage unit each time the dispensing process is performed. The identification number list stored in the memory unit 27 reflects the latest storage condition of each storage unit.

The banknote handling machine 1 further performs a collection process of collecting banknotes from each storage unit. The operation of the banknote handling machine 1 during the collection process is similar to that during the dispensing process.

(Reconciliation Process)

The reconciliation process is a process of confirming banknotes stored in the storage unit. The banknote handling machine 1 performs, as the reconciliation process, two types of processes of a full reconciliation process and a partial reconciliation process. In the full reconciliation process, all banknotes stored in the storage unit are fed out, and the number of banknotes fed is counted. In the partial reconciliation process, some of the banknotes stored in the storage unit are fed out and subjected to the matching process. The partial reconciliation process can confirm banknotes stored in the storage unit in a shorter time than the full reconciliation process.

[Full Reconciliation Process]

In a case where the banknote handling machine 1 detects removal of the storage unit from the banknote handling machine 1, the banknote handling machine 1 performs a full reconciliation process. Once the storage unit is removed, some banknotes might be taken out from the storage unit, or the order of banknotes stored in the storage unit might be changed. Once the storage unit is removed, the banknotes stored in the storage unit are uncertain. The banknote handling machine 1 needs to perform the full reconciliation process. Also in a case where the storage unit is replaced, the banknote handling machine 1 needs to perform the full reconciliation process. Further, in a case where, for example, the external terminal 29 outputs a signal instructing to perform the full reconciliation process, the banknote handling machine 1 performs the full reconciliation process. The banknote handling machine 1 may perform the full reconciliation process individually for each storage unit, or may perform the full reconciliation process sequentially for all storage units.

During the full reconciliation process, the storage unit to be subjected to reconciliation feeds the banknotes one by one. The transport unit 4 transports the banknotes fed out, to the recognition unit 25. The recognition unit 25 recognizes and counts the banknotes and reads the identification numbers. The transport unit 4 transports banknotes which are proper banknotes and whose identification numbers can be read, to, for example, a temporary storage unit 24 or an empty storage unit where no banknote is stored, and the temporary storage unit 24 or the empty storage unit stores the banknotes.

After the storage unit to be subjected to reconciliation feeds all banknotes, and the recognition unit 25 counts all banknotes, the temporary storage unit 24 or the storage unit feeds out the banknotes stored, one by one. The transport unit 4 transports the banknotes to the recognition unit 25. The recognition unit 25 again recognizes and counts banknotes and reads the identification numbers of the banknotes, and the transport unit 4 then causes the proper banknotes to be stored in the original storage unit, i.e., the storage unit to be subjected to reconciliation. In a case where the banknotes stored in the temporary storage unit 24 or the storage unit are all fed out, and the storage unit to be subjected to reconciliation stores the banknotes, the banknotes stored in the storage unit can be confirmed. The memory unit 27 updates the information on the storage unit. The memory unit 27 also updates the identification number list in the storage unit.

### [Partial Reconciliation Process]

The banknote handling machine 1 performs a partial reconciliation process when a transport abnormality occurs during transport of banknotes fed out from the storage unit or transport of banknotes to the storage unit. This is because the number of banknotes stored in the storage unit may be uncertain due to the transport abnormality. Examples of the transport abnormality herein include the case where the recognition unit 25 detects that a plurality of banknotes has been fed out in an overlapping manner during the dispensing process (i.e., occurrence of multi-feeding) and the case where banknotes being transported are jammed during the depositing process (i.e., occurrence of jam).

When multi-feeding occurs during the dispensing process, the number of banknotes fed out from the storage unit is uncertain. Thus, the number of banknotes stored in the storage unit after the dispensing process is uncertain. The banknote handling machine 1 performs a partial reconciliation process on all storage units where multi-feeding has occurred.

When a jam occurs during the depositing process, the user manually removes the banknotes to clear the jam. When a jam occurs near the entrance of the storage unit, there is a concern that the user may remove the banknote which a sensor detected having been stored in the storage unit. In such a case, an error occurs between the number of banknotes actually stored in the storage unit and the number of banknotes stored in the memory unit 27. The banknote handling machine 1 performs a partial reconciliation process on all storage units where the error may have occurred.

The partial reconciliation process uses the identification number list mentioned above. Specifically, the recognition unit 25 reads an identification numbers of the banknotes fed out from the storage unit to be subjected to reconciliation. The controller 15 performs matching of the identification numbers of the banknotes read with the identification number list. This can specify the identification numbers on the list. The identification numbers are arranged in the identification number list in order in which the banknotes are stored. In a case where the banknotes fed out from the storage unit can be specified on the identification number list, the controller 15 can confirm the banknotes which have not been fed out from the storage unit and are remaining in the storage unit, on the identification number list. In other words, the banknotes stored in the storage unit are specified. The partial reconciliation process is a process in which banknotes stored in the storage unit can be confirmed by simply feeding out only some of the banknotes stored from the storage unit. The partial reconciliation process has an advantage that the burden of the reconciliation process is reduced as compared with the full reconciliation process, and the time required for the process is significantly reduced.

### [Matching Process of Identification Numbers in Partial Reconciliation Process]

In the stack-type storage unit, the order of banknotes may be changed when the banknotes are stored. The identification number list is created in order in which banknotes pass through the recognition unit 25. Thus, if the order in which the banknotes are stored is changed, the order of banknotes in the identification number list mismatches with the order of banknotes actually stored in the storage unit. Therefore, in the case where only one banknote is fed out from the storage unit and matching of the identification number of the banknote with the identification number list is performed during the partial reconciliation process, the banknotes stored in the storage unit cannot be accurately confirmed if the order of the banknote mismatches with the order in the identification number list.

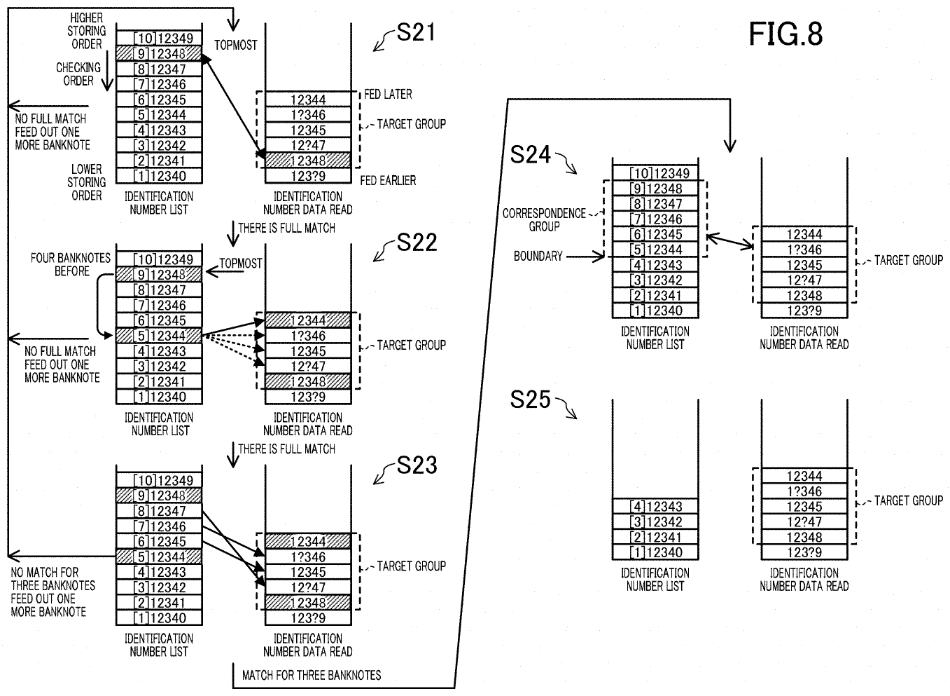

Therefore, the banknote handling machine 1 performs matching of the identification numbers of a plurality of banknotes with the identification number list during the partial reconciliation process so that the banknote handling machine 1 can address the change of the order of the banknotes. Next, procedures of the matching process of the identification numbers in the partial reconciliation process will be described with reference to FIG. 8.

In the partial reconciliation process, the recognition unit 25 reads the identification numbers of a plurality of banknotes continuously fed out from the storage unit. The minimum number of banknotes that need to be read is two. With the increase in the number of banknotes read, the accuracy of the partial reconciliation process increases, but the burden of the process and the time required for the process increase. The number of banknotes required may be determined based on the maximum number of banknotes of which the order may change when the banknotes are stored in the storage unit. In the following description, the number of banknotes that need to be read is five as an example.

As in the full reconciliation process, the storage unit to be subjected to reconciliation sequentially feeds banknotes. The transport unit 4 transports the banknotes fed out from the storage unit, to the recognition unit 25. The recognition unit 25 recognizes and counts the banknotes and reads the identification numbers. The transport unit 4 transports banknotes which are proper banknotes and for which the identification numbers can be read to a temporary storage unit 24 or an empty storage unit. The banknotes are stored in the temporary storage unit 24 or an empty storage unit. When the recognition unit 25 can read continuously identification numbers of five banknotes, the storage unit stops feeding banknotes. The controller 15 sets the identification numbers of the five banknotes including the last banknote fed out from the storage unit as a target group. The target group is a group consisting of identification numbers to be compared with the identification number list. Each of the identification numbers included in the target group corresponds to the above-mentioned target identification number.

When the recognition unit 25 could not read any identification number, the storage unit additionally feeds another banknote. The storage unit to be subjected to reconciliation may feed five or more banknotes.

The controller 15 allows there are some digits in the identification number that cannot be read. In a case where the number of digits which cannot be read is a predetermined number or less, the controller 15 determines that the identification number could be read. The storage unit does not additionally feed a banknote. This is because the controller 15 allows a mismatch of some digits in the matching process of the identification numbers, as mentioned above. Accordingly, the frequency of additional feeding of banknotes due to unreadability is reduced.

The number of digits allowed to be unreadable may be the same as the number of digits for which a mismatch is allowed in matching. The number of digits allowed to be unreadable may be less than the number of digits for which a mismatch is allowed in matching. As an example, in the case where the number of digits of the identification number is seven, if symbols of half or more of the digits, i.e., symbols of four or more of the digits have been read, the controller 15 considers that the identification number of the banknote could have been read. In a case where symbols of less than four digits are read, the controller 15 considers that the identification number of the banknote could not have been read. In such a case, the storage unit additionally feeds a banknote.

In a case where the banknote is identified as a rejected banknote, the storage unit again feeds the banknotes from the beginning. Specifically, the storage unit additionally feeds at least five banknotes in a case where the rejected banknote is identified.

In a case where the target group is determined by the procedures described above, the controller 15 performs matching of each target identification number included in the target group with the identification number list, and determines a group (i.e., a correspondence group) corresponding to the target group in the identification number list. The target group is a group corresponding to the banknotes fed out from the storage unit. Thus, the correspondence group indicates a boundary between the banknotes fed out from the storage unit and the banknotes stored in the storage unit in the identification number list. In a case where the correspondence group is specified in the identification number list, the controller 15 can confirm banknotes stored in the storage unit based on the identification number list. In a case where the group including a plurality of banknotes is specified, the controller 15 can accurately confirm the banknotes stored in the storage unit based on the identification number list even if the order in which the banknotes are stored is changed.

Next, procedures of matching the target group with the identification number list will be described below with reference to FIG. 8. In the identification number list shown in FIG. 8, “12340,” “12341,” and the like show identification numbers. The upper side of FIG. 8 shows a higher storing order, and the lower side of FIG. 8 shows a lower storing order. Specifically, the identification numbers on the lower side of FIG. 8 represent banknotes stored in the storage unit earlier, and the identification numbers on the upper side of FIG. 8 represent banknotes stored in the storage unit later. The storage unit is configured so that the banknotes stored earlier are fed out later. For this reason, the banknotes having the identification numbers on the upper side of FIG. 8 are fed out from the storage unit earlier.

The number in brackets in each identification number list of FIG. 8 represents the order of storing in the storage unit. The largest number in brackets corresponds to the number of banknotes stored in the storage unit. The “identification number data read” is an identification number read by the recognition unit 25. The identification numbers on the upper side of FIG. 8 represent the banknotes which have been fed out later, and the identification numbers on the lower side of FIG. 8 represent the banknotes which have been fed out earlier. In FIG. 8, “?” represents a digit which could not be read by the recognition unit 25. According to the technique mentioned above, the controller 15 sets the target group.

First, in step S21, the controller 15 screens for the topmost identification number in the identification number list, among identification numbers included in the target group. Specifically, the controller 15 determines the topmost identification number in the identification number list as a reference identification number, and performs a matching process between each identification number included in the target group as a target identification number with the reference identification number. The matching process differs from the above-mentioned matching process in that a match of all digits is a condition for a match of the identification number.

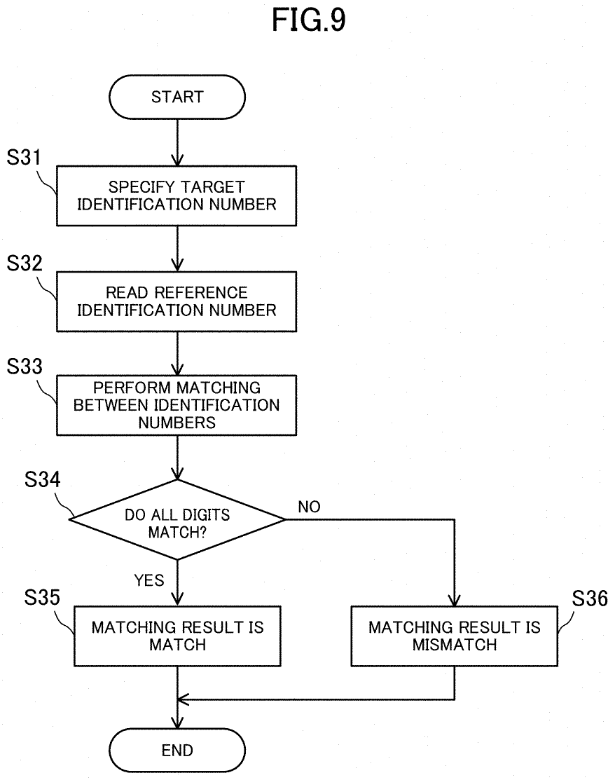

FIG. 9 is a flowchart illustrating a matching routine for the identification number that requires a match of all digits as a condition. First, in step S31, the controller 15 specifies a target identification number. The target identification number is any one of identification numbers included in a target group. In subsequent step S32, the controller 15 reads a reference identification number. The reference identification number is initially the topmost identification number in the identification number list.

In step S33, the controller 15 performs matching between the identification numbers. In step S34, the controller 15 determines whether or not symbols of all digits match between the identification numbers. In a case where symbols of all digits match, the controller 15 determines that the matching result is a match in step S35. In a case where not all the symbols of the digits match, the controller 15 determines that the matching result is a mismatch in step S36. The controller 15 repeats the matching routine of FIG. 9, while changing the target identification number sequentially, until the identification number which matches with the reference identification number is found.

In the case where the topmost identification number in the identification number list is determined as a reference identification number, and the identification number all digits of which match with those of the reference identification number is not found in the target group, the controller 15 determines the next identification number in the identification number list as a new reference identification number. The controller 15 screens the target group for an identification number which matches with the new reference identification number in accordance with the matching routine of FIG. 9.

In this way, the controller 15 determines the topmost identification number in the identification number list, among the identification numbers all digits of which match with those of the identification numbers included in the target group. The order of the identification numbers in the target group is not limited as long as the identification numbers are those included in the target group.

In step S21 of FIG. 8, if there is no identification number, in the target group, all digits of which match with those of the identification number in the identification number list, the storage unit to be subjected to reconciliation additionally feeds a banknote, and the controller 15 resets the target group to a target group including the banknote additionally fed (provided that all digits of the identification number of the banknote have been read). The controller 15 screens for the topmost identification number in the identification number list among identification numbers included in the new target group.

Once the topmost identification number in the identification number list among the identification numbers included in the target group is determined, the process proceeds to the next step S22 in FIG. 8. In FIG. 8, “12348” is the topmost identification number in the identification number list.

In step S22, the controller 15 newly sets, as a reference identification number, the identification number lower by four banknotes (referred to as the lowermost identification number herein) from the topmost identification number determined in step S21. In FIG. 8, “12344” is the lowermost identification number. The controller 15 determines whether or not an identification number all digits of which match with those of the lowermost identification number is present in the target group. At this time, the controller 15 performs a matching routine of FIG. 9 with the lowermost identification number as a reference identification number and each identification number included in the target group (excluding the topmost identification number) as a target identification number. The order of the lowermost identification number in the target group is not limited as long as the lowermost identification number is included in the target group.

If there is no identification number, in the target group, all digits of which match with those of the lowermost identification number, the storage unit to be subjected to reconciliation additionally feeds a banknote, and the controller 15 resets the target group to a target group including the banknote additionally fed. In FIG. 8, the process returns to step S21. If there is an identification number, in the target group, all digits of which match with those of the lowermost identification number, the process proceeds to the next step S23.

In step S23, the controller 15 sets, as reference identification numbers, three identification numbers between the topmost identification number and the lowermost identification number in the identification number list, and sets, as respective target identification numbers, the remaining three identification numbers included in the target group, and performs a matching process between the reference identification numbers and the target identification numbers. At this time, the controller 15 performs the matching of the identification numbers in accordance with the matching routine shown in FIG. 2. The controller 15 allows a match of only some digits of the identification number. Specifically, even if symbols of the predetermined number of digits mismatch between the reference identification number and the target identification number, the controller 15 determines that the two identification numbers match in a case where symbols of remaining digits match. The predetermined number of digits may be set as appropriate.

In the matching process of step S23, a specific digit is set. In this example configuration, the number of specific digits is two: the lowest digit and the second digit from the lowest digit in the identification number.

The identification numbers in the identification number list illustrated in FIG. 8 are “12340,” “12341,” “12342,” “12343,” . . . . The plurality of banknotes have consecutive identification numbers. In the identification numbers illustrated in FIG. 8, the position where consecutive numbers are given is the lowest digit. Numbers of the highest digit to the fourth digit are commonly “1234” for all banknotes. For example, new series notes (brand-new notes) banded may have consecutive identification numbers. In a case where the band is removed and new series notes now loose are stored in a storage unit, the plurality of banknotes stored in the storage unit have consecutive identification numbers.

In the case where the predetermined number of digits in the identification number cannot be read in the matching process or a mismatch of symbols of the predetermined number of digits is allowed in the matching process as mentioned earlier, the controller 15 can determine that all identification numbers of a plurality of banknotes are the same if a digit at a position where consecutive numbers are given is allowed to be unreadable or if a mismatch of a symbol of a digit at a position where consecutive numbers are given is allowed. As a result, the matching accuracy decreases.

Thus, in the banknote handling machine 1, the specific digits are set so as to include a digit at a position where consecutive numbers are given. Accordingly, the controller 15 determines that two identification numbers mismatch if a digit at a position where consecutive numbers are given cannot be read and if a symbol of a digit at a position where consecutive numbers are given mismatches. The controller 15 can perform matching of the identification numbers of the plurality of banknotes having consecutive identification numbers accurately.

Specifically in the example of FIG. 8, all digits of “12345” match between the reference identification number and the target identification number. A symbol of one digit of the target identification number “1?346” mismatches with that of the reference identification number “12346.” However, “46” of specific digits match. The controller 15 determines that the target identification number “1?346” matches with the reference identification number “12346.” Similarly, a symbol of one digit of the target identification number “12?47” mismatches with that of the reference identification number “12347.” However, “47” of specific digits match. The controller 15 determines that the target identification number “12?47” matches with the reference identification number “12347.” The controller 15 does not limit the order of the identification numbers in the target group in the matching of the identification numbers in step S23. If all the identification numbers corresponding to the three identification numbers are present in the target group, the process proceeds to step S24.

If symbols of specific digits do not match between the reference identification number and the target identification number, the controller 15 determines that the reference identification number mismatches with the target identification number. If the number of digits for which symbols mismatch exceeds the predetermined number, the controller 15 determines that the reference identification number mismatches with the target identification number.

In step S23, in a case where the identification numbers corresponding to the three identification numbers in the identification number list are not present in the target group, the storage unit to be subjected to reconciliation additionally feeds a banknote, and the controller 15 resets the target group. In FIG. 8, the process returns to step S21.

In step S24, the controller 15 specifies the correspondence group on the identification number list. The correspondence group is a group including all identification numbers, in any order but consecutively, which match with the identification numbers included in the target group. The correspondence group corresponds to a boundary between the banknote fed out from the storage unit and the banknotes stored in the storage unit after the feeding. The lowermost identification number and upper identification numbers from the lowermost identification number in the correspondence group are identification numbers of banknotes fed out from the storage unit.

In subsequent step S25, the controller 15 deletes information on the correspondence group and identification numbers listed above the correspondence group in the identification number list. In the example of FIG. 8, the controller 15 deletes “12344” and identification numbers listed above “12344.” When the controller 15 updates the identification number list, the banknotes stored in the storage unit are confirmed.

Thereafter, the temporary storage unit 24 or the storage unit feeds banknotes stored therein one by one, and the transport unit 4 transports the banknotes to the recognition unit 25. The recognition unit 25 recognizes and counts the banknotes and reads the identification numbers. The transport unit 4 stores banknotes which are proper banknotes and for which identification numbers are read into the original storage unit. The memory unit 27 updates information on the storage unit and the identification number list, and the partial reconciliation process ends.

In this way, in the partial reconciliation process, the controller 15 can specify banknotes stored in the storage unit by simply feeding out only some of the banknotes stored in the storage unit. The partial reconciliation process reduces the burden of the reconciliation process and the time required for the process as compared with the full reconciliation process.

In the partial reconciliation process, the controller 15 performs matching of a plurality of identification numbers in any order. The controller 15 can accurately specify banknotes stored in the storage unit without being affected by the change of the order in which the banknotes are stored. Further, in the matching process of the identification numbers, the controller 15 allows a mismatch of some digits of the identification number, which is advantageous in reducing the burden of the process. On the other hand, for the topmost identification number and the lowermost identification number in the correspondence group, a match of all digits is a condition for determining that the identification numbers match, which allows the controller 15 to accurately specify the correspondence group. The accuracy of the reconciliation process thus improves.

In the case of allowing a mismatch of some digits of the identification number, the position of the consecutive numbers is set as a specific digit. Also in the case where the identification numbers of a plurality of banknotes stored in the storage unit have consecutive numbers, the controller 15 can accurately specify the banknotes stored in the storage unit by the partial reconciliation process.

In the above description, the controller 15 performs the matching process of the topmost identification number and the lowermost identification number in accordance with the matching routine of FIG. 9. However, the controller 15 may perform the matching process of the topmost identification number and the lowermost identification number in accordance with the matching routine of FIG. 2. In other words, the controller 15 may perform the matching process of the identification numbers in which a mismatch of some digits is allowed under the condition where specific digits match.

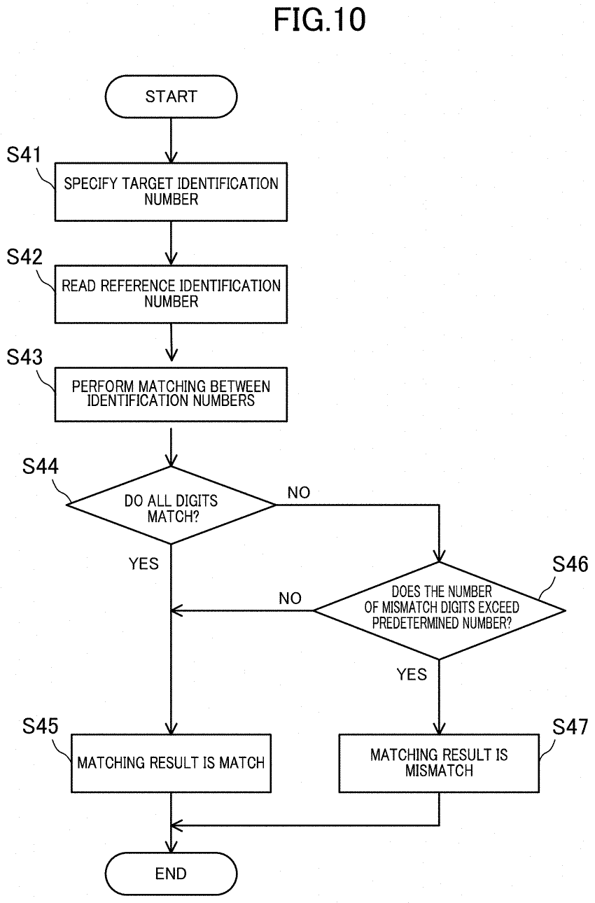

In the above description, the controller 15 perform the matching process of three identification numbers between the topmost identification number and the lowermost identification number in accordance with the matching routine of FIG. 2. However, the controller 15 may perform the matching process without setting of specific digits. FIG. 10 illustrates a matching routine where a specific digit is not set. First, in step S41, the controller 15 specifies a target identification number. In this case, the target identification number is any one of the three identification numbers other than the identification numbers corresponding to the topmost identification number and the lowermost identification number. The controller 15 uses the three identification numbers as the target identification numbers sequentially.

In subsequent step S42, the controller 15 reads a reference identification number. The reference identification number is any one of the three identification numbers between the topmost identification number and the lowermost identification number in the identification number list. In step S43, the controller 15 compares the identification numbers. In step S44, the controller 15 determines whether or not symbols of all digits match between the identification numbers. In a case where symbols of all digits match between the identification numbers, the controller 15 determines that the matching result is a match in step S45. In a case where not all the symbols of digits match, the controller 15 determines whether or not the number of digits for which symbols mismatch exceeds the predetermined number in step S46. In a case where the number of digits for which symbols mismatch does not exceed the predetermined number, the controller 15 determines that the matching result is a match in step S45. In a case where the number of digits for which symbols mismatch exceeds the predetermined number in step S46, the controller 15 determines that the matching result is a mismatch in step S47.

(Method of Setting Position of Specific Digit)

As mentioned above, the specific digit may be set so as to include a digit indicating consecutive numbers. However, the position of the digit indicating the consecutive numbers is not the same for all currencies and/or denominations. Numbers, letters, and marks constituting the identification number are arranged according to a specific rule. The specific rule is determined for each attribute of the banknote. For example, a specific rule is determined for each currency, or even for the same currency, a specific rule is determined for each denomination, for example. Thus, the position of the digit indicating the consecutive numbers in the identification number may be different for each currency or each denomination.

The memory unit may store information on the currencies to be handled by the banknote handling system and specific digits corresponding to each currency in association with each other, and the control unit may set the number and positions of the specific digits in the matching process based on the information on the currency of the banknote recognized by the recognition unit and information stored in the memory unit. The memory unit may store information on the denominations to be handled by the banknote handling system and specific digits corresponding to each denomination in association with each other, and the control unit may set the number and positions of the specific digits in the matching process based on the information on the denomination of the banknote recognized by the recognition unit and information stored in the memory unit.

Instead of the memory unit storing information on the specific digits, the control unit may set positions of the specific digits in accordance with a characteristic of the identification number read by the recognition unit.

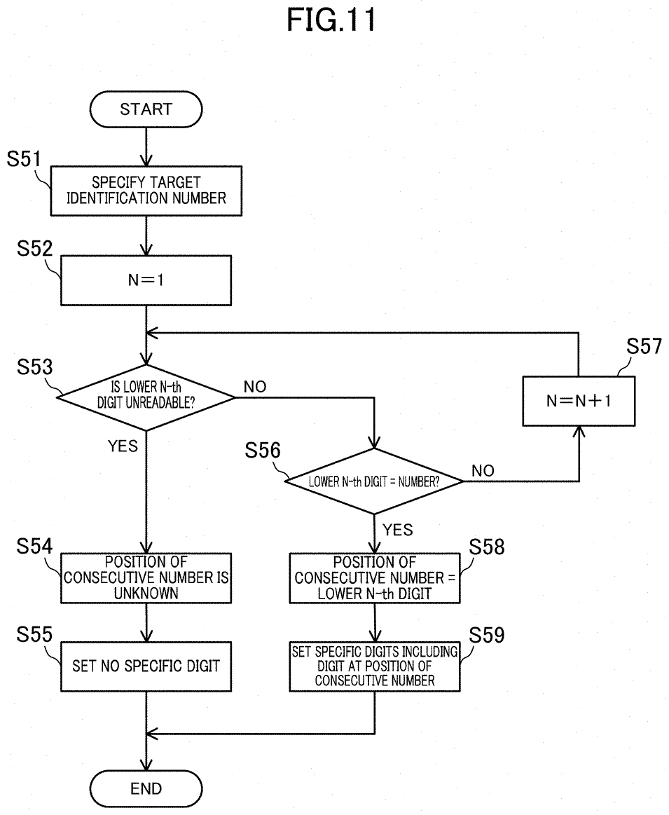

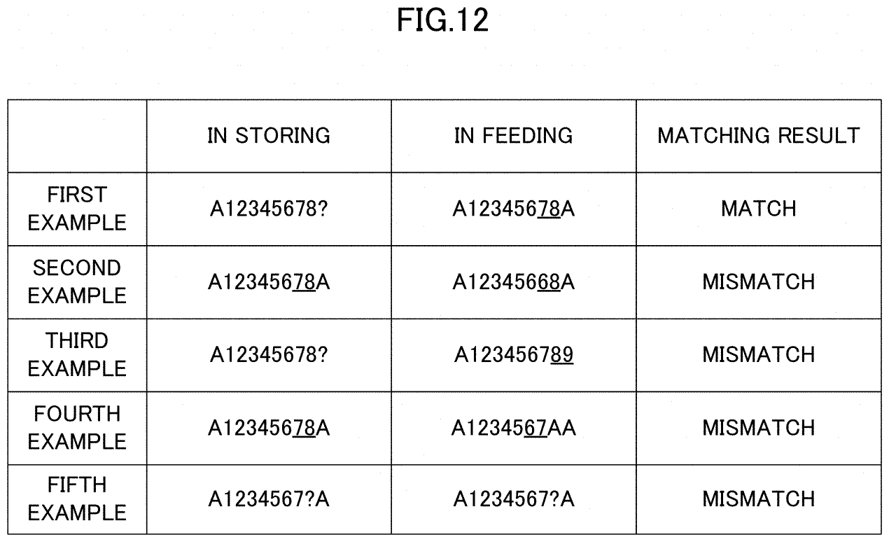

Next, with reference to FIGS. 11 and 12, a method of setting positions of specific digits in accordance with the characteristic of the identification number read from the banknote will be described in detail below.

The identification number to be subjected to matching includes a combination of letters and numbers as illustrated in FIG. 12. The number of digits of the identification number is ten. Symbols of the highest digit and the lowest digit are letters, and symbols of the second to ninth digits from the highest digit are numbers.

In the example configuration described herein, the number of specific digits set is two: the eighth and ninth digits from the highest digit. The numbers of the last two digits of a string of numbers of a plurality of digits are consecutive numbers in the plurality of banknotes having consecutive identification numbers. In the method of setting specific digits described herein, the control unit screens the identification number including numbers and letters for the digits of numbers constituting consecutive numbers, and sets these digits of numbers as the specific digits.

Specifically, the control unit of the banknote handling system screens for numbers from the lowest digit to higher digits in the identification number read by the recognition unit. Then, the control unit determines that the digit of the number first found constitutes the consecutive numbers. The control unit sets, as the specific digits, the predetermined number of digits including the digit of the number first found.

FIG. 11 is a flowchart illustrating procedures related to setting of specific digits, performed by the control unit. First, in step S51, the control unit specifies a target identification number. The control unit receives information on the identification number from the recognition unit, for example. In subsequent step S52, the control unit sets a counter N to 1. The counter N corresponds to the position of a digit of a number to be screened for.

In step S53, the control unit determines whether or not the lower N-th digit of the target identification number is unreadable. If N=1, the control unit determines whether or not the lowest digit of the identification number is unreadable. In a case where the lower N-th digit cannot be read, the process proceeds to step S54, and in a case where the lower N-th digit can be read, the process proceeds to step S56.

In step S54, the control unit determines that the position of the consecutive number is unknown, and in subsequent step S55, the specific digit is not set. The process of setting the specific digit for this identification number ends. Specifically, the control unit screens for a digit of a number from the lowest digit to the higher digits in the identification number, but in a case where an unreadable digit is present before a digit of a number is found, the control unit does not set the specific digit for the identification number.

In step S56, the control unit determines whether or not the symbol of the lower N-th digit is a number. If the symbol of the lower N-th digit is a number, the process proceeds to step S58, and if the symbol of the lower N-th digit is not a number, the process proceeds to step S57.

In step S57, the control unit adds 1 to the counter N, and the process returns to step S53. If N=2 in step S57, the control unit determines whether or not the second digit from the lowest digit in the identification number is unreadable in step S53.

In step S58, the control unit sets the lower N-th digit (i.e., for example, the lowest digit if N=1, and the second digit from the lowest digit if N=2) in the identification number as the position of the consecutive number in the identification number, and in subsequent step S59, the control unit sets, as specific digits, digits including the digit at the position of the consecutive number and the predetermined number of digits higher than the digit at the position of the consecutive number.

The control unit can set specific digits so as to include a digit indicating consecutive numbers for the identification numbers having various characteristics in accordance with the flowchart of FIG. 11.

Next, the matching process of the identification number will be described below with reference to FIG. 12. The matching process includes setting of specific digits based on the flowchart of FIG. 11. A specific example of FIG. 12 corresponds to the matching process in the above-mentioned partial reconciliation process. Specifically, in the process of storing banknotes into the storage unit, i.e., the depositing process, the recognition unit reads identification numbers of the banknotes, and the memory unit stores the identification numbers. Further, in the process of feeding out the banknotes from the storage unit, e.g., in the partial reconciliation process, the recognition unit reads the identification numbers of the banknotes, and the control unit performs matching of the identification numbers read with the identification numbers of the banknotes stored in the memory unit during storage of the banknotes.

The process of feeding out the banknotes from the storage unit may be, for example, a dispensing process. Further, the process of feeding out the banknotes from the storage unit may also be, for example, a collection process. The process of storing the banknotes into the storage unit may be, for example, a replenishing process.

The first example in FIG. 12 is an example where the lowest digit of the identification number could not be read in the storing. In the storing, the control unit does not set specific digits. As will be described later, in FIG. 12, specific digits set by the control unit are underlined.

In the first example, the recognition unit could read all digits in the feeding. The identification number read is “A12345678A.” The symbol of the lowest digit in the identification number is a letter, and the symbol of the second digit from the lowest digit is a number. As underlined in FIG. 12, the control unit sets the second and third digits from the lowest digit as specific digits.

The control unit also performs matching between the identification number read in the storing and the identification number read in the feeding. In this case, a digit for which the symbol mismatches is only the lowest digit, and the symbols of the specific digits match. Since the number of digits for which symbols mismatch is the predetermined number or less, and the symbols of the specific digits match, the control unit determines that the two identification numbers match. The control unit performs the matching process according to the specific digits in a case where the specific digits are set in at least one of the storing or the feeding.

A second example is an example where symbols of specific digits mismatch. The identification number read in the storing is “A12345678A.” As underlined in FIG. 12, the control unit sets the second and third digits from the lowest digit as specific digits. The identification number read in the feeding is “A12345668A.” As underlined in FIG. 12, the control unit sets the second and third digits from the lowest digit as specific digits.

The control unit also performs matching between the identification number read in the storing and the identification number read in the feeding. In this case, the positions of the specific digits match between the identification number read in the storing and the identification number read in the feeding. The digit for which the symbol mismatches between the two identification numbers is only one digit which is the third digit from the lowest digit, but is included in the specific digits. Thus, the control unit determines that the two identification numbers mismatch.

A third example is also an example where symbols of specific digits mismatch. The identification number read in the storing is “A12345678?.” Specifically, the control unit could not read the lowest digit in the storing. Accordingly, specific digits are not set. The identification number read in the feeding is “A123456789.” As underlined in FIG. 12, the control unit sets the lowest digit and the second digit from the lowest digit as specific digits.

The control unit also performs matching between the identification number read in the storing and the identification number read in the feeding. In this case, the control unit handles the digit which has not been read as a digit for which the symbol mismatches. The digit for which symbol mismatches is only the lowest digit, but is included in the specific digits. Thus, the control unit determines that the two identification numbers mismatch.

A fourth example is an example where positions of specific digits set in the storing differ from those set in the feeding. The identification number read in the storing is “A12345678A,” and specific digits thereof are two digits, i.e., the second and third digits from the lowest digit. The identification number read in the feeding is “A1234567AA,” and the control unit sets two digits, i.e., the third and fourth digits from the lowest digit, as specific digits.

The control unit also performs matching between the identification number read in the storing and the identification number read in the feeding. In this case, the positions of the specific digits set in the storing differ from those set in the feeding. The control unit determines that the two identification numbers mismatch.

A fifth example is an example where specific digits cannot be set in both storing and feeding. The identification number read in the storing is “A1234567?A,” and the control unit does not set specific digits. The identification number read in the feeding is “A1234567?A,” and the control unit does not set specific digits.

The control unit also performs matching between the identification number read in the storing and the identification number read in the feeding. In this case, the digit for which the symbol mismatches is only one digit, but the specific digits of the identification number cannot be set in both the storing and the feeding. Thus, the control unit determines that the two identification numbers mismatch.

Since the control unit sets specific digits according to the characteristics of the identification number read, the control unit can set the position of the consecutive numbers in the identification number as a specific digit regardless of the currency and the denomination. If the specific digits cannot be set for the two identification numbers to be subjected to matching, and the specific digits differ between the two identification numbers, the control unit determines that the two identification numbers mismatch, so that the control unit can perform the matching of the identification numbers appropriately.

The present disclosure is applicable not only to the banknote handling system with each of the configurations mentioned above, but also to the banknote handling systems with various configurations. For example, the present disclosure is applicable to a banknote counting machine having no storage unit and configured to take banknotes from a deposit unit, recognize the number or denominations of the plurality of banknotes taken therein, and dispense the recognized banknotes to a dispense unit. For example, the present disclosure is applicable to a banknote sorting machine having no storage unit and configured to take banknotes from a deposit unit, recognize denominations and fitness of the plurality of banknotes taken therein, and sort and dispense the recognized banknotes into a plurality of dispense units.

What is claimed is:

1. A banknote handling system comprising:
a transport member that transports a banknote having a unique code consisting of a string of a plurality of symbols;
a recognition circuit that reads a code of the banknote transported by the transport member;
a memory that stores a first code; and
a controller that performs a matching process of matching of a second code of the banknote to be subjected to matching read by the recognition circuit with the first code stored in the memory, wherein
the controller
determines that the first code matches with the second code if a symbol of at least one specific digit at a specific position of the first code all matches with that of the second code and if the number of digits for which symbols mismatch other than the at least one specific digit is a predetermined number or less, and
determines that the first code mismatches with the second code if the symbol of the at least one specific digit of the first code mismatches with that of the second code or if the number of digits for which symbols mismatch other than the at least one specific digit exceeds the predetermined number.

2. The banknote handling system of claim 1, wherein
the controller receives an input signal related to the at least one specific digit and sets the at least one specific digit based on the input signal.

3. The banknote handling system of claim 1, wherein
the memory stores correspondence information between an attribute of the banknote and the at least one specific digit, and
the controller sets the at least one specific digit based on the attribute of the banknote to be subjected to matching.

4. The banknote handling system of claim 1, wherein
the controller receives an input signal related to an attribute of the banknote and sets the at least one specific digit based on the input signal.

5. The banknote handling system of claim 1, wherein
the recognition circuit further recognizes an attribute of the banknote to be subjected to matching, and
the controller sets the at least one specific digit based on the attribute recognized by the recognition circuit.

6. The banknote handling system of claim 1, further comprising:
at least one storage for storing a banknote, the controller performs the matching process of a banknote fed out from the at least one storage,
the at least one storage stores a banknote of the same attribute, and
the controller sets the at least one specific digit based on the at least one storage which has fed out the banknote.

7. The banknote handling system of claim 1, wherein
the at least one specific digit is set based on a characteristic of the code.

8. The banknote handling system of claim 1, wherein
the controller sets the at least one specific digit based on a characteristic of the second code read by the recognition circuit.

9. The banknote handling system of claim 1, wherein
the code includes at least two types of symbols among a number, a letter, and a mark, and
the at least one specific digit includes at least one digit for any one of the types of symbols.

10. The banknote handling system of claim 9, wherein
the at least one specific digit includes a digit for a number.

11. The banknote handling system of claim 9, wherein
the code includes a plurality of digits for a string of numbers, and
the at least one specific digit includes a lowest digit in the string of numbers.

12. The banknote handling system of claim 1, wherein
the controller performs various types of processes related to the banknote, each of the various types of processes being performed with the matching process, and
the at least one specific digit is set according to a type of a process performed.

13. The banknote handling system of claim 1, wherein
the memory stores the first code related to a counterfeit note and a specific digit corresponding to the first code, and
the controller performs a process of extracting a counterfeit note by performing the matching process using the first code.

14. The banknote handling system of claim 1, further comprising:
at least one storage for storing a banknote,
the memory stores codes of all the banknotes stored in the at least one storage as the first code,
the recognition circuit reads the code of the banknote fed out from the at least one storage as the second code, and
the controller performs a reconciliation process of confirming the number of banknotes stored in the at least one storage by performing the matching process.

15. The banknote handling system of claim 1, wherein
the code includes a plurality of digits for a string of numbers and a digit of a letter,
the at least one specific digit consists of the predetermined number of digits including the lowest digit in the string of numbers, and
the controller screens for the digits for numbers in the code of the banknote read by the recognition circuit sequentially from the lowest digit to higher digits, and sets the predetermined number of digits from the digit for a number first found, as the at least one specific digit.

16. The banknote handling system of claim 15, wherein
the controller does not set the at least one specific digit in a case where there is an unreadable digit before the digit for a number is found in the screening.

17. The banknote handling system of claim 15, further comprising:
a storage for storing a banknote,
the recognition circuit reads a code of the banknote before the storage stores the banknote, the controller sets the at least one specific digit based on the code read, the memory stores the code read, as the first code,
the recognition circuit reads a code of the banknote fed out from the storage, as a second code, the controller sets the at least one specific digit based on the second code read, and
the controller performs the matching process according to the at least one specific digit in a case where the at least one specific digit is set in at least one of the storing or the feeding.

18. The banknote handling system of claim 17, wherein
the controller determines that the first code mismatches with the second code if the at least one specific digit cannot be set in both the storing and the feeding or if a position of the at least one specific digit set differs between the storing and the feeding.

19. A banknote handling method, comprising:
storing, in a memory, a first code as a unique code of a banknote;
transporting the banknote by a transport member;
reading, by a recognition circuit, a code of the banknote transported by the transport member as a second code; and
performing, by a controller, a matching process of matching the second code read by the recognition circuit with the first code stored in the memory for the banknote to be subjected to matching, wherein
each of the codes includes a string of a plurality of symbols and has at least one digit at a specific position set to be a specific digit, and
the controller determines
that the first code matches with the second code if the symbol of the at least one specific digit of the first code all matches with that of the second code and if the number of digits for which symbols mismatch other than the at least one specific digit is a predetermined number or less, and
that the first code mismatches with the second code if the symbol of the at least one specific digit of the first code mismatches with that of the second code or if the number of digits for which symbols mismatch other than the at least one specific digit exceeds the predetermined number.
